(19) United States
(12) Patent Application Publication
(10) Pub. No.: US 2016/0191995 A1
(43) Pub. Date: Jun. 30, 2016

(54) IMAGE ANALYSIS FOR ATTENDANCE QUERY EVALUATION

(71) Applicant: Affectiva, Inc., Waltham, MA (US)

(72) Inventors: Rana el Kaliouby, Milton, MA (US); Nicholas Langeveld, Darien, CT (US); Daniel McDuff, Cambridge, MA (US); Seyedmohammad Mavadati, Watertown, MA (US)

(21) Appl. No.: 15/061,385

(22) Filed: Mar. 4, 2016

Related U.S. Application Data
(63) Continuation-in-part of application No. 14/848,222, filed on Sep. 8, 2015.
Application No. 14/848,222 is a continuation-in-part of application No. 13/153,745, filed on Jun. 6, 2011.
Application No. 14/848,222 is a continuation-in-part of application No. 14/460,915, filed on Aug. 15, 2014.
Application No. 14/460,915 is a continuation-in-part of application No. 13/153,745, filed on Jun. 6, 2011.
Application No. 13/153,745 is a continuation-in-part of application No. 13/249,317, filed on Sep. 30, 2011.
(60) Provisional application No. 62/128,974, filed on Mar. 5, 2015.
(60) Provisional application No. 62/217,872, filed on Sep. 12, 2015.
(60) Provisional application No. 62/222,518, filed on Sep. 23, 2015.
(60) Provisional application No. 62/265,937, filed on Dec. 10, 2015.
(60) Provisional application No. 62/273,896, filed on Dec. 31, 2015.
(60) Provisional application No. 62/301,558, filed on Feb. 29, 2016.
(60) Provisional application No. 62/047,508, filed on Sep. 8, 2014.
(60) Provisional application No. 62/082,579, filed on Nov. 20, 2014.
(60) Provisional application No. 62/128,974, filed on Mar. 5, 2015.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/867,007, filed on Aug. 16, 2013.
(60) Provisional application No. 61/924,252, filed on Jan. 7, 2014.
(60) Provisional application No. 61/916,190, filed on Dec. 14, 2013.
(60) Provisional application No. 61/927,481, filed on Jan. 15, 2014.
(60) Provisional application No. 61/953,878, filed on Mar. 16, 2014.
(60) Provisional application No. 61/972,314, filed on Mar. 30, 2014.
(60) Provisional application No. 62/023,800, filed on Jul. 11, 2014.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.

(51) Int. Cl. H04N 21/442; G06T 7/00; H04N 21/81; H04N 21/466; H04N 21/25; H04N 21/45; G06K 9/00; H04N 21/4223

(52) U.S. Cl. CPC H04N 21/44218; G06K 9/00288; G06T 7/004; G06K 9/00268; H04N 21/4223; H04N 21/4667; H04N 21/251; H04N 21/4532; G06K 9/0061; H04N 21/812; G06T 2207/30201

(57) ABSTRACT

Facial evaluation is performed on one or more videos captured from an individual viewing a display. The images are evaluated to determine whether the display was viewed by the individual. The individual views a media presentation that includes incorporated tags and is rendered on the display. Based on the tags, video of the individual is captured and evaluated using a classifier. The evaluating includes determining whether the individual is in front of the screen, facing the screen, and gazing at the screen. An engagement score and emotional responses are determined for media and images provided on the display.

### RELATED APPLICATIONS

This application claims the benefit of U.S. provisional patent applications “Viewership Analysis Based on Facial Evaluation” Ser. No. 62/128,974, filed Mar. 5, 2015, “Mental State Event Signature Usage” Ser. No. 62/217,872, filed Sep. 12, 2015, “Image Analysis In Support of Robotic Manipulation” Ser. No. 62/222,518, filed Sep. 23, 2015, “Analysis of Image Content with Associated Manipulation of Expression Presentation” Ser. No. 62/265,937, filed Dec. 12, 2015, “Image Analysis Using Sub-Sectional Component Evaluation To Augment Classifier Usage” Ser. No. 62/273,896, filed Dec. 31, 2015, and “Analytics for Live Streaming Based on Image Analysis within a Shared Digital Environment” Ser. No. 62/301,558, filed Feb. 29, 2016.

This application is also a continuation-in-part of U.S. patent application “Facial Tracking with Classifiers” Ser. No. 14/848,222, filed Sep. 8, 2015 which claims the benefit of U.S. provisional patent applications “Facial Tracking with Classifiers” Ser. No. 62/047,508, filed Sep. 8, 2014, “Semiconductor Based Mental State Analysis” Ser. No. 62/082,579, filed Nov. 20, 2014, and “Viewership Analysis Based On Facial Evaluation” Ser. No. 62/128,974, filed Mar. 5, 2015. The patent application “Facial Tracking with Classifiers” Ser. No. 14/848,222, filed Sep. 8, 2015 is also a continuation-in-part of U.S. patent application “Mental State Analysis Using Web Services” Ser. No. 13/153,745, filed Jun. 6, 2011, which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. The patent application “Facial Tracking with Classifiers” Ser. No. 14/848,222, filed Sep. 8, 2015 is also a continuation-in-part of U.S. patent application “Mental State Analysis Using an Application Programming Interface” Ser. No. 14/460,915, Aug. 15, 2014, which claims the benefit of U.S. provisional patent applications “Application Programming Interface for Mental State Analysis” Ser. No. 61/867,007, filed Aug. 16, 2013, “Mental State Analysis Using an Application Programming Interface” Ser. No. 61/924,252, filed Jan. 7, 2014, “Heart Rate Variability Evaluation for Mental State Analysis” Ser. No. 61/916,190, filed Dec. 14, 2013, “Mental State Analysis for Norm Generation” Ser. No. 61/927,481, filed Jan. 15, 2014, “Expression Analysis in Response to Mental State Express Request” Ser. No. 61/953,878, filed Mar. 16, 2014, “Background Analysis of Mental State Expressions” Ser. No. 61/972,314, filed Mar. 30, 2014, and “Mental State Event Definition Generation” Ser. No. 62/023,800, filed Jul. 11, 2014. The application “Mental State Analysis Using an Application Programming Interface” Ser. No. 14/460,915, Aug. 15, 2014 is also a continuation-in-part of U.S. patent application “Mental State Analysis Using Web Services” Ser. No. 13/153,745, filed Jun. 6, 2011, which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011.

This application is also a continuation-in-part of U.S. patent application “Measuring Affective Data for Web-Enabled Applications” Ser. No. 13/249,317, filed Sep. 30, 2011 which claims the benefit of U.S. provisional patent applications “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011.

The foregoing applications are each hereby incorporated by reference in their entirety.

### FIELD OF ART

This application relates generally to image analysis and more particularly to image analysis for attendance query evaluation.

### BACKGROUND

Computerized image analysis has become increasingly prevalent in a variety of applications. As computer processing power increases and the cost of processors and memory decreases, it is now possible to perform computerized image analysis in devices available to the typical consumer. Human facial image analysis is one such computerized image analysis that has become an increasingly important technology. Facial image analysis can include aspects such as face detection, face recognition, face tracking, eye tracking, and so on.

Computerized image analysis can include various image processing techniques such as edge detection, feature detection, and landmark identification. Processing can include gamma correction, contrast adjustment, spatial filtering, two-dimensional Laplace transforms, and other techniques. Thus, computerized image analysis of human faces can provide utility in a variety of applications such as biometrics, gaming, and user interface design, to name a few. Advancement in computing technology makes it possible to provide this functionality on mobile devices such as mobile phones, tablets, and other smart devices.

The human face is routinely analyzed for a variety of purposes including determination of a range of emotions and mental states, facial recognition, motion capture, eye tracking, lie detection, computer animation, and so on. As humans are presented daily with dizzying amounts of video data that is viewed on a range of displays, the range of human emotions that are detected includes engagement in the media presentation, since some of the video data is interesting and engaging to the viewer while other video data does not engage the viewer.

Various entities involved in the production and distribution of video content have an interest in determining the number of viewers who have watched the content. As such, viewer information can be used for a variety of purposes, including adjusting the schedule of programs, the lineup of channels, and estimating the value of advertisements that are presented to viewers.

The entertainment industry utilizes a variety of statistical measurements to reflect the number of viewers who have watched a particular program or video. Two frequently used measurements are ratings and shares. Ratings and shares are often used by the television industry. A rating measurement is representative of the number of devices that have presented a particular piece of content relative to a total number of devices that were capable of presenting this content. For instance, assume that a television network provides services to a sample of 100 set-top boxes. If 25 of these set-top boxes are tuned to a particular program, then the rating of that program is 25 percent. On the other hand, a share measurement is representative of the number of television units that presented a particular program relative to a total number of television units that were actually presenting programs in a prescribed time frame. Thus, shares take in to account how many people were actually watching. In recent years, more and more content is being viewed through “over the top” channels via the Internet from various video sites, both free and subscription-based. While the content delivery technology is different, content stakeholders still have an interest in understanding the popularity and effectiveness of their content.

### SUMMARY

Image acquisition hardware acquires a plurality of images of a person as they are viewing an event on an electronic display. The event can include a video, television program, movie, and/or advertisement. The plurality of images may be received from a webcam. The electronic display may render an advertisement. The plurality of images is evaluated to determine an engagement score and emotional responses. Based on the engagement score and the emotional responses, a determination is made that the electronic display was viewed (attended to). The score can also serve as a quantitative measure of interest or engagement that the content invokes.

A computer-implemented method for analysis is disclosed comprising: receiving a plurality of images of an individual viewing an electronic display; identifying a face of the individual wherein the identifying is based on a plurality of image classifiers and wherein the identifying occurs for at least one of the plurality of images; and evaluating the plurality of images to determine that the electronic display was attended by the individual. Tagging is invoked based on tags that are incorporated into video material. The tags can activate an image acquisition sequence to acquire a plurality of images. Collection of the plurality of images is based on opting-in by the individual. The received plurality of images is evaluated to determine an engagement score and to evaluate emotional responses. Embodiments can include determining an engagement score for the individual. The engagement score and emotional responses are used in determining if a particular piece of content was viewed, and determine a measure of the interest generated by the content.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram representing attendance query evaluation.

FIG. 2 is a flow diagram representing display attendance.

FIG. 3 is an example illustrating lines of sight.

FIG. 4A is an example showing display attendance.

FIG. 4B is an example illustrating facial data.

FIG. 5 is a diagram showing image collection including multiple mobile devices.

FIG. 6 illustrates feature extraction for multiple faces.

FIG. 7 shows live streaming of social video with viewership analysis.

FIG. 8 shows example facial data collection including landmarks.

FIG. 9 shows example facial data collection including regions.

FIG. 10 is a flow diagram for detecting facial expressions.

FIG. 11 is a flow diagram for the large-scale clustering of facial events.

FIG. 12 shows unsupervised clustering of features and characterizations of cluster profiles.

FIG. 13A shows example tags embedded in a webpage.

FIG. 13B shows invoking tags to collect images.

FIG. 14A shows a perspective view of an embodiment utilizing multiple screens.

FIG. 14B shows a top-down view of an embodiment utilizing multiple screens.

FIG. 15 shows an exemplary calibration user interface for a multiple screen embodiment.

FIG. 16 is a diagram of a system for analyzing images for attendance query evaluation.

### DETAILED DESCRIPTION

Humans observe and process various stimuli, including media content, with engagement or other emotional reaction. The economic value of media content is often tied to how engaging it is. Thus for advertisements, the more an advertisement is watched, the more valuable it is. In particular, for content such as advertisements and programs, it is desirable to have information regarding the number of people who viewed the content. However, just because media content is rendered (such as played on a computer screen) does not necessarily mean it was viewed. For example, a baseball game might be presented on a television, but a person could merely have the game on in the background, only occasionally looking at the television to check the score. In another example, an advertisement that is not engaging might cause a viewer to look away or check their e-mail while waiting for the advertisement to complete. In such a situation, even though the advertisement was presented to the user, the user was not really watching it. The fact that a user was inattentive to the content can be valuable feedback for content stakeholders. For a content network, this information can serve as a point of negotiation for content costs and advertising rates. For advertisers, this information can help them learn which advertisements are engaging and which advertisements do not hold significant viewer interest. As millions of people view a particular website/webpage, the advertising client wants to know if the advertisement that is hosted on that site was actually viewed. Armed with this information, advertisers can refine and hone the advertisements for maximal effect.

Disclosed embodiments utilize image analysis using image classifiers to measure how much the content was actually viewed, which can in turn provide a more authentic measure of how engaging the content is. In order to make accurate assessments of the attention-holding properties of content, a significant sample size can be beneficial. Hence, the images for analysis are preferably acquired using consumer grade equipment such as webcams, or the cameras typically found in mobile devices, such as tablets and smart phones.

In disclosed embodiments, one or more images of an individual are obtained. The images can be captured using a camera or another image capture device, a sensor, etc. The images can be videos, frames of a video, still images, or other image capture media. The face of the individual is identified in an image. Regions within the face of the individual are determined, where the regions can include eyebrows, eyes, a nose, a mouth, ears, etc.

In embodiments, the user opts in to allow the webcam or camera on their device to be used to acquire images of him while he is viewing content. In some embodiments, the opt-in is persistent, so that the user does not have to opt in every time. In this way, the user can be evaluated using the low-cost cameras that are part of their devices. In embodiments, the users are incentivized to opt in. For example, the users can be given coupons, product discounts, free products, vouchers, and/or other incentives to opt in. Statistics regarding the willingness of consumers to opt in can be collected. Various questions can be posed to the consumers, such as, “Can we contact you to join a study?” and “How interested would you be in this type of opportunity?” The query results can be analyzed to determine a variety of factors. For example, data can be collected and analyzed to determine what drives consumer interest. The analysis results can be presented graphically, as percentages, for example.

Systems in accordance with disclosed embodiments analyze the images using image classifiers. Actions are detected, such as looking away, averting the eyes, or leaving the area, and then recorded by the system. Systems in accordance with disclosed embodiments compute a score based on what percentage of the time the viewer is actually looking at the content while the content is being played. Techniques such as head pose analysis and eye gaze analysis are used for determining if the user is looking at the screen. The scores, collected in large numbers, can provide a meaningful statistic that helps assess the interest level and economic value of media content, providing important information for content providers and distributors.

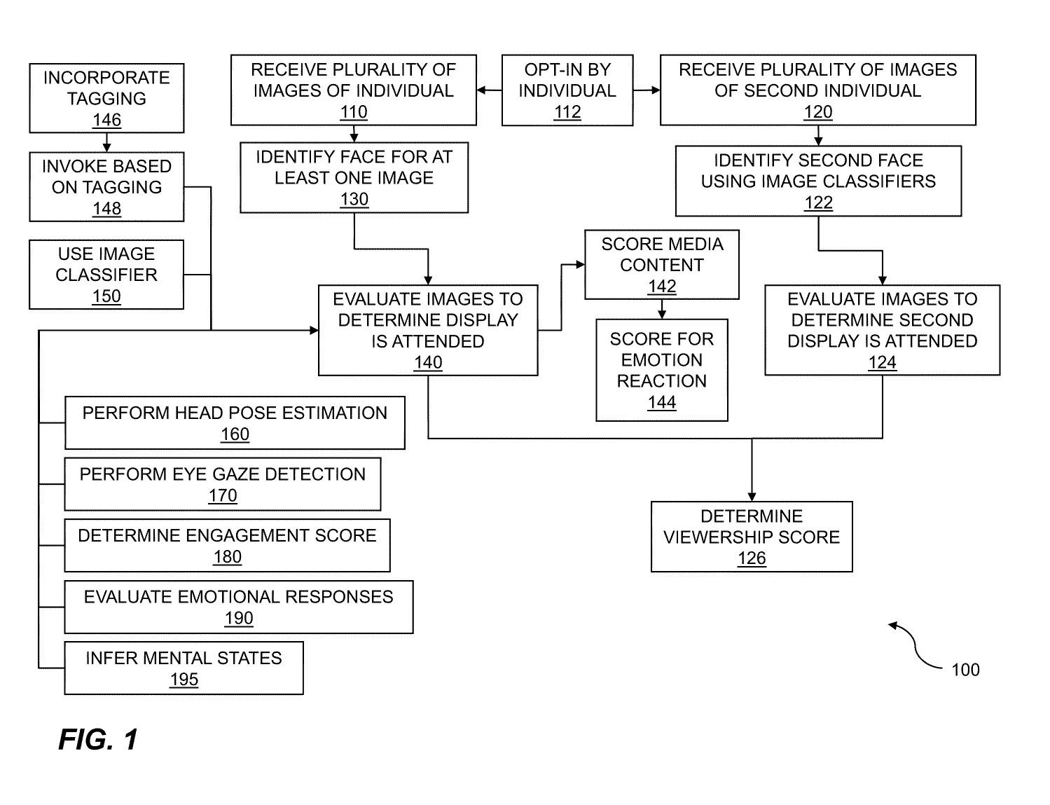

FIG. 1 is a flow diagram representing attendance query evaluation. The flow 100 can include opt-in by individuals 112. The opt-in indicates permission to acquire images of the individual for the purposes of performing image analysis for attendance query evaluation. Thus, embodiments include opting in by the individual for collection of the plurality of images. The attendance query evaluation is an assessment of viewership. In embodiments, the opt-in is persistent, such that once the user opts in, they do not need to continue to opt in for subsequent attendance query evaluation sessions. Thus, in some embodiments, receiving of the plurality of images is accomplished without further consent by the individual. In some embodiments, opting in is persistent and was accomplished before an advertisement is rendered on the electronic display. In such embodiments, the camera turns on without additional consent (after the first opt-in), making the experience more unobtrusive. In embodiments, the evaluating of the plurality of images to determine that the electronic display was attended by the individual is used as part of a viewership determination across a plurality of people.

The flow 100 continues with receiving a plurality of images of an individual 110. The images can be received via a camera such as a webcam that is integrated into a laptop computer or a camera integrated into a mobile device such as a tablet or smart phone, for example. The flow 100 continues with identification of a face for at least one image 130. The identifying can be based on a plurality of image classifiers. One or more image classifiers can be used to isolate and identify a face within one of the images. The identifying occurs for at least one of the plurality of images that were collected. The plurality of image classifiers are used to perform head pose estimation. The head is determined to be within an image. An image classifier further determines that the head is oriented such that the face is pointed toward the electronic display. In embodiments, the head pose is further estimated to include eye gaze evaluation such that the eyes are gazing in the direction of the electronic display.

The flow 100 further continues with evaluation of the images to determine that a display is attended 140. In embodiments, the display is part of the same device that houses the camera performing the image acquisition. In other embodiments, the display is separate from the device that houses the camera that performs the image acquisition. A variety of techniques are used to perform the evaluation 140, including the use of image classifiers to determine head pose orientation and eye gaze direction. In embodiments, the aforementioned process is performed on multiple individuals. Thus, the flow 100 can also include receiving a plurality of images of a second individual 120, identifying the second face using image classifiers 122, and evaluating images to determine if a second display is attended 124. Thus, embodiments further comprise receiving a second plurality of images of a second individual viewing a second electronic display, identifying a second face of the second individual wherein the identifying the second face is based on the plurality of image classifiers and wherein the identifying the second face occurs for at least one of the second plurality of images, evaluating the second plurality of images to determine that the second electronic display was attended by the second individual, and determining a viewership score based on the evaluating the plurality of images and the evaluating the second plurality of images. In practice, thousands or even millions of individuals can be analyzed to determine an attendance query evaluation.

The flow 100 can include incorporating tagging 146. Tagging includes placement of codes or identifiers referred to as “tags” in content such as web pages. The tags can indicate a particular display condition, and an action is invoked based on tagging 148. A tag can indicate when a particular image or video is viewable on a webpage. For example, a particular video might not be visible until a user scrolls down on the web page. Once the user has scrolled down sufficiently to reveal the video, the tag can invoke an action to start an attendance query evaluation session. Receiving a plurality of images of an individual viewing an electronic display can be in response to tagging of media rendered on the electronic display.

The flow 100 can continue with using image classifiers 150. The image classifiers can be algorithms, pieces of code, heuristics, etc., that can be used to detect a face in one or more images. For example, the classifiers can be developed and stored locally, can be purchased from a provider of classifiers, can be downloaded from a web service such as an ftp site, and so on. The classifiers can be categorized and used based on the analysis requirements. In a situation where videos are obtained using a mobile device and classifiers are also executed on the mobile device, the device might require that the analysis be performed quickly while using minimal memory, and thus a simple classifier can be implemented and used for the analysis. Alternatively, a requirement that the analysis be performed accurately and more thoroughly than is possible with only a simple classifier can dictate that a complex classifier be implemented and used for the analysis. Such complex classifiers can include one or more expression classifiers, for example. Other classifiers can also be included.

The flow 100 can include performing head pose estimation 160. The head pose estimation can be used to determine if an individual is facing the direction of the content display. In embodiments, performing head pose estimation is accomplished using a plurality of image classifiers. In some embodiments, head pose estimation comprises determining the presence of a face and that the face is directed in the direction of the electronic display. In some embodiments, an image classifier from the plurality of image classifiers is used to evaluate head pose for the individual. In some embodiments, evaluating the plurality of images to determine that the electronic display was attended by the individual is accomplished using an image classifier from the plurality of image classifiers. If it is determined that the user is not facing the direction of the content display, it indicates that she/he might not be watching or paying attention to the content. The flow 100 can include performing eye gaze detection 170. In embodiments, performing eye gaze detection is accomplished using a plurality of image classifiers. The eye gaze detection can further evaluate an attendance query evaluation. Thus, even in a situation where the individual is facing the content display (screen), their eyes might be averted, thus indicating that the content is not being viewed, despite the fact that they are facing toward the content display. The flow 100 can continue with determining an engagement score 180. In embodiments, the engagement score is computed as a percentage of the time that the individual was viewing the content. In this case, the engagement score ES is a percentage determined by:

ES=V/T

where ES is the engagement score, V is the total time an individual views the content, and T is the total duration of the content. For example, if a piece of content is ten minutes in duration, and the system determines, based on image analysis, that the individual was watching for 7 minutes and 24 seconds, then the engagement score is 444/600=74%.

The flow 100 can further include evaluating emotional responses 190. In some embodiments, invoking the evaluating is based on tagging that was incorporated in media. In embodiments, as part of the evaluating, mental states can be inferred for the individual including one or more of sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, curiosity, humor, poignancy, or mirth. Thus, the flow 100 can include inferring mental states 195. The mental states can be inferred based on the evaluated emotional responses. Understanding an individual's mental state as he or she views a piece of media content can be valuable for a variety of reasons, such as measuring effectiveness of advertisements, determining which parts of a video most please a specific user, or determining a user's preferences in order to better suggest what other content the specific user might find appealing, just to name a few. In embodiments, the electronic display renders an advertisement, and the advertisement has tagging incorporated.

Referring again to the evaluation 140, the operations described by callouts 146, 148, 150, 160, 170, 180, 190, and 195 contribute to the evaluation of images to determine if a content display is attended by an individual. In embodiments, being attended by the individual includes viewing of the electronic display. Furthermore, in embodiments, determination that the electronic display was attended is used in determining viewership.

The flow can continue with scoring the media content 142. The media content score can be a function of the engagement score of multiple individuals. For example, if 10,000 individuals are analyzed for attendance query evaluation for a particular piece of media content, then the engagement score for each of the individuals can be averaged to derive a score for the media content. In some embodiments, a certain threshold is established to discard outliers from the computation of the media content score. Referring again to the example with 10,000 individuals, if a threshold of 1 percent is established, then the bottom 100 individuals (those with the lowest engagement scores) and the top 100 individuals (those with the highest engagement scores) can be discarded from the media content score computation. In this way, the outliers do not impact the media content score. The emotional engagement value can be compared to regional norms by including geographical data, demographics, and so on.

The flow 100 can continue with scoring for emotional reaction 144. Thus, in addition to determining if content was viewed, embodiments also combine an emotional reaction score. For example, if an individual is watching the content, but appears bored or confused, that typically would be an undesirable effect that results in a lower emotional reaction score. Conversely, if an individual is laughing or appears excited, that typically would be a desirable effect that results in a higher emotional reaction score. The emotional reaction of a consumer to a given advertisement can have a significant impact on brand consideration. For example, if a consumer experiences happiness or amusement while viewing an advertisement, the consumer is more likely to have a favorable emotional reaction to the brand and brand consideration. In contrast, if the consumer experiences boredom, then the consumer is less likely to have a favorable emotional reaction to the brand and brand consideration. As a consumer moves through the purchase funnel, emotion and engagement can be leading drivers behind the consumer decision-making process.

The flow can continue with determining a viewership score 126. In embodiments, the scoring includes scoring for emotional reaction by the individual. Thus, the viewership score can be a function of the media content score for engagement, the emotional reaction score, and the viewability. The viewability is a measure of how available the content is, as it is a measure of how many times the content was presented. In the context of television, the viewability can be a measure of how many televisions (or set-top boxes) were tuned to a specific program. In the context of Internet video, the viewability can be a measure of how many times a particular video was playing and visible on a display. The aforementioned tagging process can be used in determining viewability for Internet video content. Thus, in embodiments, the viewership score is an aggregate of engagement, emotional reaction, and viewability. In some embodiments, the emotional reaction includes engagement. The resulting score provides a meaningful indication about the effectiveness of media content.

Viewership pertains to how much content was actually viewed, while engagement is a measure of how interested or focused on the content the viewer is. Thus, engagement is a combination of the viewership metric combined with facial expression data. Furthermore, viewership is similar to an AND function. If viewership is low, then there is no need to look at engagement, because clearly the viewer's target of attention is not the content. Some (upper-face) muscle activations (AU1+2 or AU4) can indicate an intensifying of the engagement level. Fixed eye gaze and tilting the head can intensify the engagement and also indicate confusion. Fixed eye gaze and small head movements (e.g. head nodding) can be another indicator of high attention (e.g. considering temporal or repetition of some actions). Moving the head toward the screen (with the gaze following that) is yet another indicator of high engagement.

Determinations of viewership can be based on identifying whether a viewer is present, identifying when the viewer looks away, and identifying when the gaze of a viewer is averted. Other viewership determinations can be made. Face detection can be based on a percentage of time spent viewing or facing the content display, derived from analysis of captured video. For example, face detection might be rated at 92% but could then drop to 0%. Such a change in face detection can indicate that the consumer was present early on and then left. Identifying when a viewer looks away can be determined by head pose estimation. For example, if the head pose indicates that a consumer is viewing an advertisement, then the consumer is likely looking at the advertisement. If the head pose indicates that the consumer has turned her or his head away from the display, then the consumer is likely not viewing the advertisement. Identifying when the gaze of a viewer (consumer) is averted can be determined by determining eye and pupil direction.

The viewership metric can be based on eye and pupil direction. Eye blink rate and synchronicity can be based on analyzing facial features of the captured video of a consumer. Facial expressions can be determined from the captured video and can include magnitude and dynamics values. Combining the viewership metric, eye blink rate and synchronicity, and facial expressions can be used to determine an emotional engagement score. The score can be based on any range of numbers.

In some embodiments, facial recognition is used to cancel the analysis if the identified face does not match the face of the opt-in individual. For example, if a computer is shared by a family, and only one family member opted in, then if another user who did not opt in is using the computer, then the system can cancel the image acquisition. Thus, in embodiments, the opt-in only applies to the individual or individuals who actually did opt in. Other individuals using that computer are not recognized as people that opted in, and thus, their information is not collected. Thus, embodiments use facial recognition to determine if the individual viewing the content is a user that previously opted in for attendance query evaluation. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

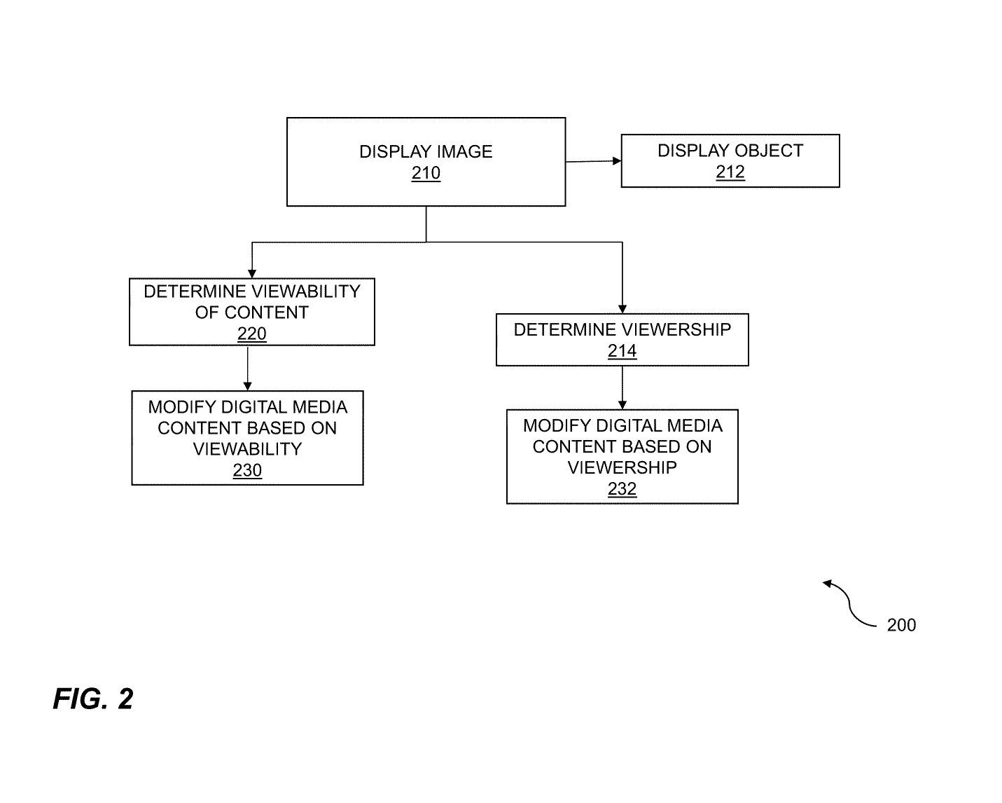

FIG. 2 is a flow diagram representing display attendance. The flow 200 includes displaying an image 210. In embodiments, the image is a web page. The flow 200 continues with display of an object 212 within the image. In embodiments, the object is a video embedded within a web page. In embodiments, the electronic display renders an object and the viewing includes viewing the object. The flow 200 can continue with determining the viewability of content 220. In embodiments, being attended by the individual includes determining viewability of digital media content from the electronic display. The digital media content can include an advertisement. In embodiments, viewability includes evaluation of presence of digital media content and whether the digital media content is viewable by the individual. The determining of the viewability can be performed utilizing tags within web pages. Some web pages serve a continual sequence of videos to a web page. For example, a news website can continually serve news videos to a web page. If the user scrolls to the bottom of the webpage, the video could be playing, but not visible on the screen. In some embodiments, a browser plug-in performs additional checks. For example, the browser plug-in can use the IsWindowVisible API function for Microsoft Windows™, or an equivalent function, to determine if the browser is obscured by another window. Thus, even if the user does not scroll the video off of the display, there is still a chance that the video is not viewable. For example, the user can place another window such as a spreadsheet window or e-mail composition screen over the video. In such a scenario, the video would be deemed not visible. In some embodiments, the video is partially obscured. For example, the user can place a spreadsheet application such that it partially covers the video window. In some embodiments, a percentage of overlap is computed by calculating the area of the overlapping region of each window that overlaps the video. If the overlap exceeds a predetermined threshold, then the video can be deemed not viewable for the purposes of determining viewability. For example, if more than 25 percent of the video is obscured, the video can be considered unviewable. However, in a case where a user has positioned another application so it just slightly covers an edge of the video window, that video is still considered viewable, so long as the percentage of overlap is below the predetermined threshold.

The flow 200 can continue with modifying digital media content based on viewability 230. In embodiments, the viewability status as a function of time is recorded by the system. Based on changes in viewability status, the digital media content can be modified. For example, if it is determined that on average, after 30 seconds into a 2-minute advertisement, the user scrolls or covers the video with another application, then it is deemed as a loss of interest in the video. That information can be used to modify the digital media content. The modifications can include changing the audio volume on the video, editing the video to add or remove scenes, or replacing the video altogether.

The flow 200 can include determining viewership 214. The determination of viewership is based on image classifiers for assessing characteristics including, but not limited to, head pose estimation, eye gaze detection, engagement scores, emotional responses and/or mental states. The flow 200 can continue with modifying the digital media content based on viewership 232. For example, if it is determined that on average, after 30 seconds into a 2-minute advertisement, the user looks away, averts his eyes, or leaves the area, then it is deemed as a loss of interest in the video. That information can be used to modify the digital media content, with modifications that can include changing the audio volume on the video, editing the video to add or remove scenes, or replacing the video altogether. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

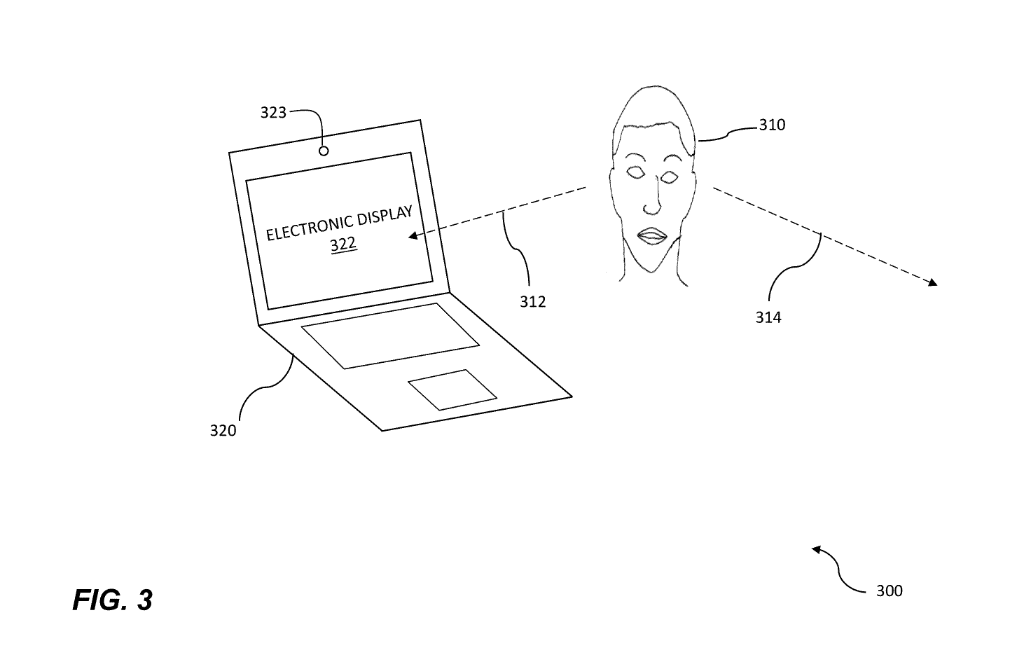

FIG. 3 is an example illustrating lines of sight. The example 300 shows a person 310 viewing an event on one or more electronic displays. In practice, any number of displays can be shown to the person 310. An event can be a media presentation, where the media presentation can be viewed on an electronic display. The media presentation can be an advertisement, a political campaign announcement, a TV show, a movie, a video clip, or any other type of media presentation. In the example 300, the person 310 has a line of sight 312 to a computer 320 that includes an electronic display 322. Similarly, the person 310 can look away from the electronic display 322 along a line of sight 314. While one person has been shown, in practical use, embodiments of the present invention can analyze groups comprising thousands of people or more. In embodiments including groups of people, each person has a line of sight 312 to the event or media presentation rendered on an electronic display 322. The plurality of captured videos can be of people who are viewing substantially identical media presentations or events, or conversely, the videos can capture people viewing different events or media presentations.

The computer 320 further includes a webcam 323 that acquires images of the person 310 as they view content rendered on the electronic display 322. The webcam 323 can be used to capture data from the person 310. While FIG. 3 shows a webcam 323 integrated into the device that is rendering the video, other embodiments include an additional or alternative camera, including, but not limited to, a video camera, a still camera, a 3-D camera, a thermal imager, a CCD device, a three-dimensional camera, a light field camera, multiple webcams used to show different views of the viewers, or any other type of image capture apparatus that allows captured image data to be used in an electronic system. The content displayed on the electronic display 322 can include media presentations such as an advertisement, a political campaign announcement, a TV show, a movie, a video clip, or any other type of media presentation. The media can be oriented toward an emotion. For example, the media can include comedic material to evoke happiness, tragic material to evoke sorrow, and so on.

The facial data from the webcam 323 is received by a video capture module which can decompress the video into a raw format from a compressed format such as H.264, MPEG-2, or the like. Facial data that is received can be received in the form of a plurality of videos, with the possibility of the plurality of videos coming from a plurality of devices. The plurality of videos can be of one person and of a plurality of people who are viewing substantially identical situations or substantially different situations. The substantially identical situations can include viewing media and/or viewing still photographs. The facial data can include information on action units, head gestures, eye movements, muscle movements, expressions, smiles, and the like.

The raw video data comprised of a plurality of images can then be processed for attendance query evaluation. The processing can include analysis of head pose data, eye gaze data, expression data, action units, gestures, mental states, and so on. Facial data as contained in the raw video data can include information on one or more of action units, head gestures, smiles, brow furrows, squints, lowered eyebrows, raised eyebrows, attention, and the like. The action units can be used to identify smiles, frowns, and other facial indicators of expressions. Gestures can also be identified, and can include a head tilt to the side, a forward lean, a smile, a frown, as well as many other gestures.

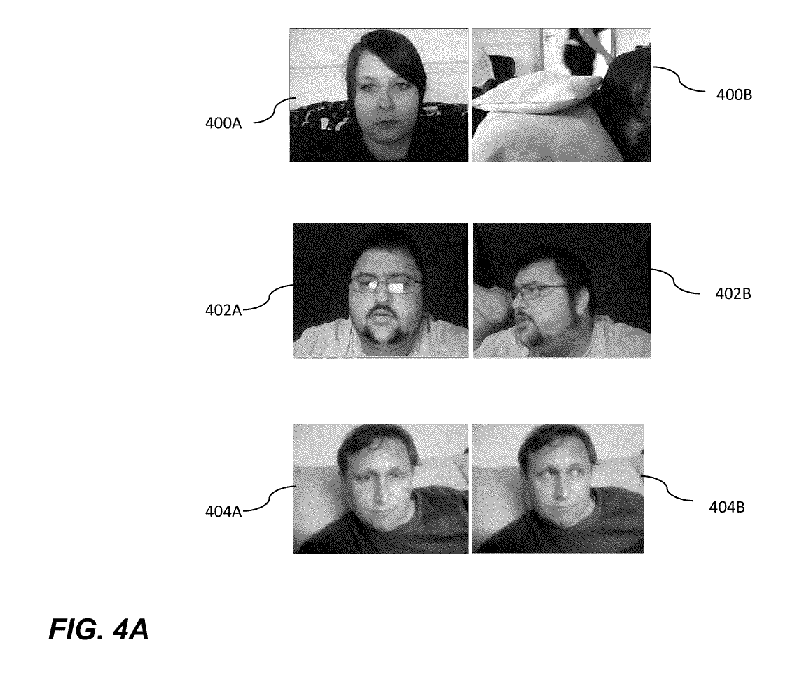

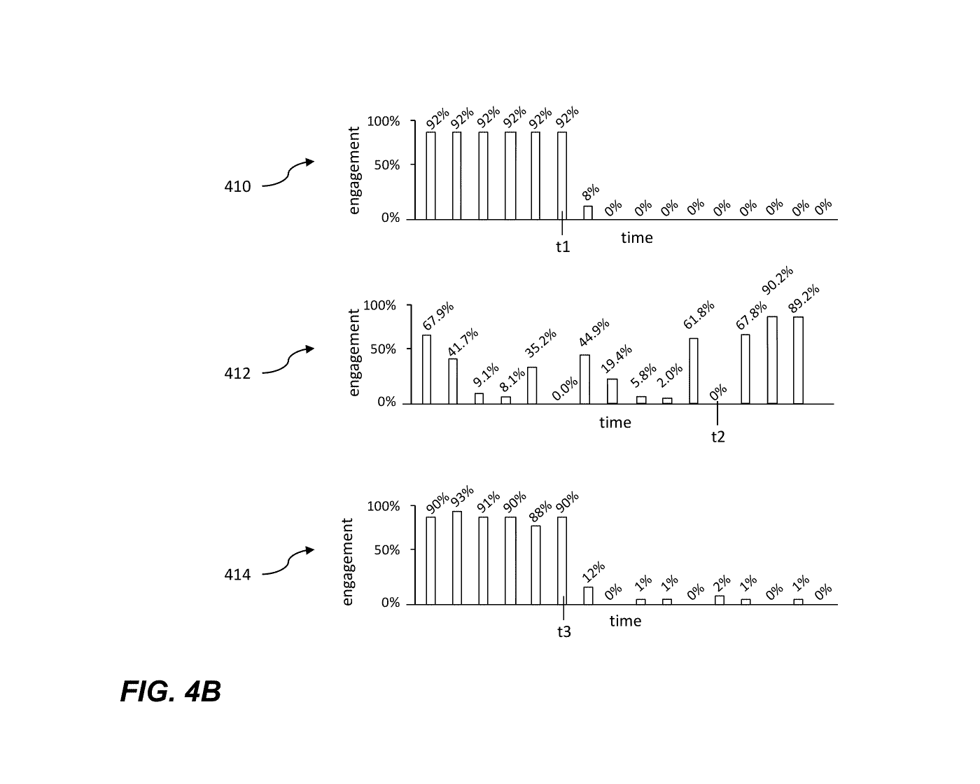

FIG. 4A shows examples of display attendance. In FIG. 4A, there are three sets of images. Each set of images is from an individual undergoing an attendance query evaluation session. Image 400A shows a first individual at a first time during presentation of video content. In image 400A, the first individual is watching the content. Image 400B shows a view of the first individual at a second time during presentation of video content. Image 400B indicates that the individual has left the area, and thus, is no longer viewing the content. Thus, using face detection, it is possible to accurately detect when the viewer's departure occurs.

Image 402A shows a second individual at a first time during presentation of video content. In image 402A, the second individual is watching the content. Image 402B shows a view of the second individual at a second time during presentation of video content. Image 402B indicates that the second individual has turned his head and is no longer facing the content, and thus, the second individual is no longer viewing the content. Embodiments use head pose estimation, which determines the position of the head in 3D space, making it possible to infer if the person is facing the screen and at what angle they are facing the screen. This is not a binary measure, but rather an analog measure depending on head angle.

Image 404A shows a third individual at a first time during presentation of video content. In image 404A, the third individual is watching the content. Image 404B shows a view of the third individual at a second time during presentation of video content. Image 404B indicates that the third individual, while still facing the screen, has averted his eyes, and thus his eyes are no longer directed towards the content, and thus, the third individual is no longer viewing the content. Thus, even if the person is present and facing the screen, it is possible that the person's gaze is averted away from the content. A typical case is when a person is texting on the phone while the content is playing. To determine if the eyes are focused on the screen showing the content of interest, embodiments utilize a method that learns the location of the pupils within the eye, and combines this with head pose information, and an assumption about the location of the camera with respect to the screen, to infer whether the eyes are looking at the screen or away from the screen. Note that the aforementioned eye gaze processing is different from (and much less compute-intensive than) eye tracking, which can require special hardware and an extensive calibration step as well as controlled settings in regards to lighting and other factors. Even in the case of webcam-based eye tracking, there is a calibration step and strict requirements for lighting. Also, if the person moves their face or body, re-calibration is required. While this eye tracking works in controlled “lab” environments, it has not proved feasible for spontaneous, natural viewing environments where a consumer is naturally watching a video. Thus, in embodiments, evaluating the plurality of images is accomplished without eye tracking.

FIG. 4B is an example illustrating facial data. FIG. 4B includes three charts, charts 410, 412, and 414. Each chart has a horizontal axis of time, and a vertical axis of an engagement level. Each bar on the chart may represent a time window comprising a fixed unit of time, such as one minute. The chart 410 corresponds to the sequence of images 400A and 400B of FIG. 4A. Up until time t1, the engagement level is at 92%, indicating that the user is mostly focused on the displayed content. After time t1, the next bar indicates a very low engagement level because at some point during that time window, the user left the area. In the subsequent time windows, the engagement level is zero, as the individual is no longer present.

The chart 412 corresponds to the sequence of images 402A and 402B of FIG. 4A. In this example, the individual remains present in front of the rendered content, but for a portion of the video, he frequently looks away. As can be seen in the chart 412, up until time t2, the engagement level is sporadic, fluctuating between low and midrange levels. After time t2, the engagement level increases. In such an embodiment where digital media content is modified based on viewership, a chart such as 412 indicates that the ending of the video is engaging to the individual, while earlier in the video, before time t2, the video was not as engaging. Thus, in embodiments, the modification includes shortening the video by deleting and/or shortening scenes of the video prior to time t2, in order to better hold the individual's attention and interest.

The chart 414 corresponds to the sequence of images 404A and 404B of FIG. 4A. In this example, the individual remains present in front of the rendered content, but for a portion of the video, he is frequently looking away by averting his gaze away from the screen that is presenting the media content. As can be seen in chart 414, up until time t3, the engagement level is relatively high, indicating a high level of focus by the individual on the media content. After time t3, the engagement level significantly decreases. In such an embodiment where digital media content is modified based on viewership, a chart such as 414 indicates that the beginning of the video is engaging to the individual, while later in the video, after time t3, the video was not as engaging. Thus, in embodiments, the modification includes shortening the video by deleting and/or shortening scenes after time t3, in order to better hold the individual's attention and interest. In this way, the information obtained by disclosed embodiments can help tailor media content to be more engaging and effective.

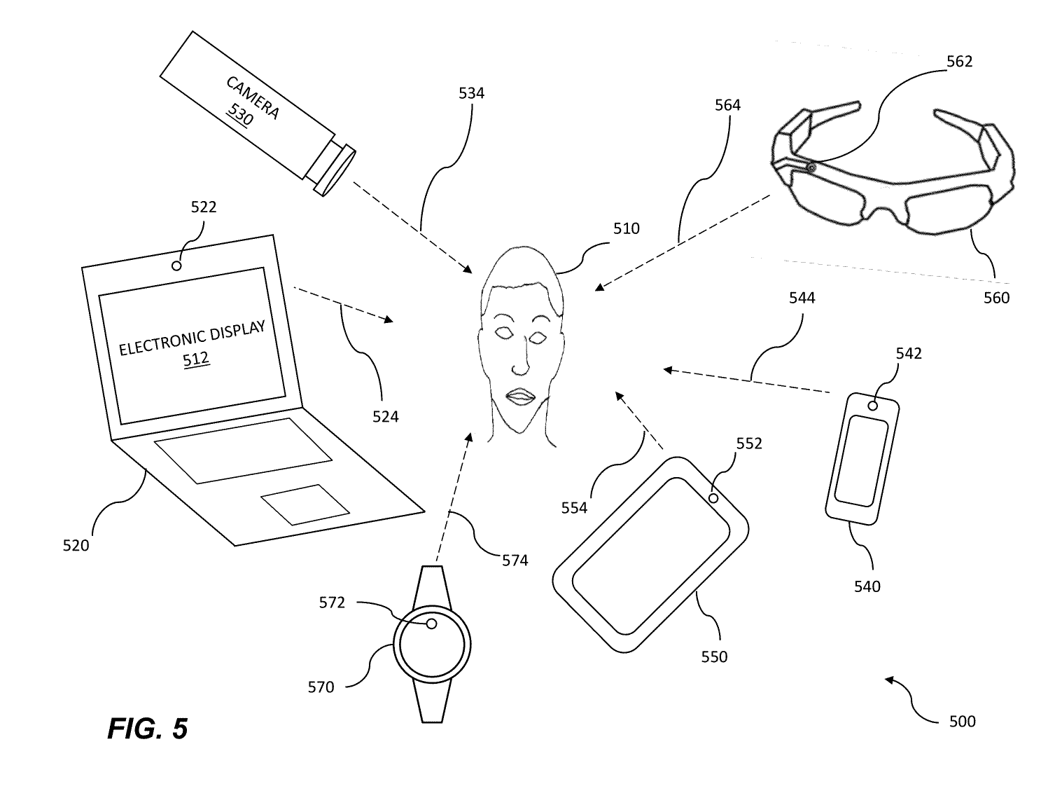

FIG. 5 is a diagram showing image collection including multiple mobile devices. The collected images can be analyzed for attendance query evaluation. A plurality of images of an individual viewing an electronic display can be received. A face can be identified in an image, based on the use of image classifiers. The plurality of images can be evaluated to determine that the electronic display was attended by the individual. In the diagram 500, the multiple mobile devices can be used singly or together to collect video data on a user 510. While one person is shown, the video data can be collected on multiple people. A user 510 can be observed as she or he is performing a task, experiencing an event, viewing a media presentation, and so on. The user 510 can be shown one or more media presentations, political presentations, or social media, or another form of displayed media. The one or more media presentations can be shown to a plurality of people. The media presentations can be displayed on an electronic display 512 or another display. The data collected on the user 510 or on a plurality of users can be in the form of one or more videos, video frames, still images, etc. The plurality of videos can be of people who are experiencing different situations. Some example situations can include the user or plurality of users being exposed to TV programs, movies, video clips, social media, and other such media. The situations could also include exposure to media such as advertisements, political messages, news programs, and so on. As noted before, video data can be collected on one or more users in substantially identical or different situations and viewing either a single media presentation or a plurality of presentations. The data collected on the user 510 can be analyzed and viewed for a variety of purposes including expression analysis, mental state analysis, and so on. The electronic display 512 can be on a laptop computer 520 as shown, a tablet computer 550, a cell phone 540, a television, a mobile monitor, or any other type of electronic device. In one embodiment, expression data is collected on a mobile device such as a cell phone 540, a tablet computer 550, a laptop computer 520, or a watch 570. Thus, the multiple sources can include at least one mobile device, such as a phone 540 or a tablet 550, or a wearable device such as a watch 570 or glasses 560. A mobile device can include a forward facing camera and/or a rear-facing camera that can be used to collect expression data. Sources of expression data can include a webcam 522, a phone camera 542, a tablet camera 552, a wearable camera 562, and a mobile camera 530. A wearable camera can comprise various camera devices such as the watch camera 572.

As the user 510 is monitored, the user 510 might move due to the nature of the task, boredom, discomfort, distractions, or for another reason. As the user moves, the camera with a view of the user's face can be changed. Thus, as an example, if the user 510 is looking in a first direction, the line of sight 524 from the webcam 522 is able to observe the user's face, but if the user is looking in a second direction, the line of sight 534 from the mobile camera 530 is able to observe the user's face. Furthermore, in other embodiments, if the user is looking in a third direction, the line of sight 544 from the phone camera 542 is able to observe the user's face, and if the user is looking in a fourth direction, the line of sight 554 from the tablet camera 552 is able to observe the user's face. If the user is looking in a fifth direction, the line of sight 564 from the wearable camera 562, which can be a device such as the glasses 560 shown and can be worn by another user or an observer, is able to observe the user's face. If the user is looking in a sixth direction, the line of sight 574 from the wearable watch-type device 570, with a camera 572 included on the device, is able to observe the user's face. In other embodiments, the wearable device is another device, such as an earpiece with a camera, a helmet or hat with a camera, a clip-on camera attached to clothing, or any other type of wearable device with a camera or other sensor for collecting expression data. The user 510 can also use a wearable device including a camera for gathering contextual information and/or collecting expression data on other users. Because the user 510 can move her or his head, the facial data can be collected intermittently when she or he is looking in a direction of a camera. In some cases, multiple people can be included in the view from one or more cameras, and some embodiments include filtering out faces of one or more other people to determine whether the user 510 is looking toward a camera. All or some of the expression data can be continuously or sporadically available from the various devices and other devices. The changes in the direction in which the user 510 is looking or facing can be used in determining engagement with a piece of media content.

The captured video data can include facial expressions and can be analyzed on a computing device such as the video capture device or on another separate device. The analysis could take place on one of the mobile devices discussed above, on a local server, on a remote server, and so on. In embodiments, some of the analysis takes place on the mobile device, while other analysis takes place on a server device. The analysis of the video data can include the use of a classifier. The video data can be captured using one of the mobile devices discussed above and sent to a server or another computing device for analysis. However, the captured video data including expressions can also be analyzed on the device which performed the capturing. The analysis can be performed on a mobile device where the videos were obtained with the mobile device and wherein the mobile device includes one or more of a laptop computer, a tablet, a PDA, a smartphone, a wearable device, and so on. In another embodiment, the analyzing comprises using a classifier on a server or another computing device other than the capturing device.

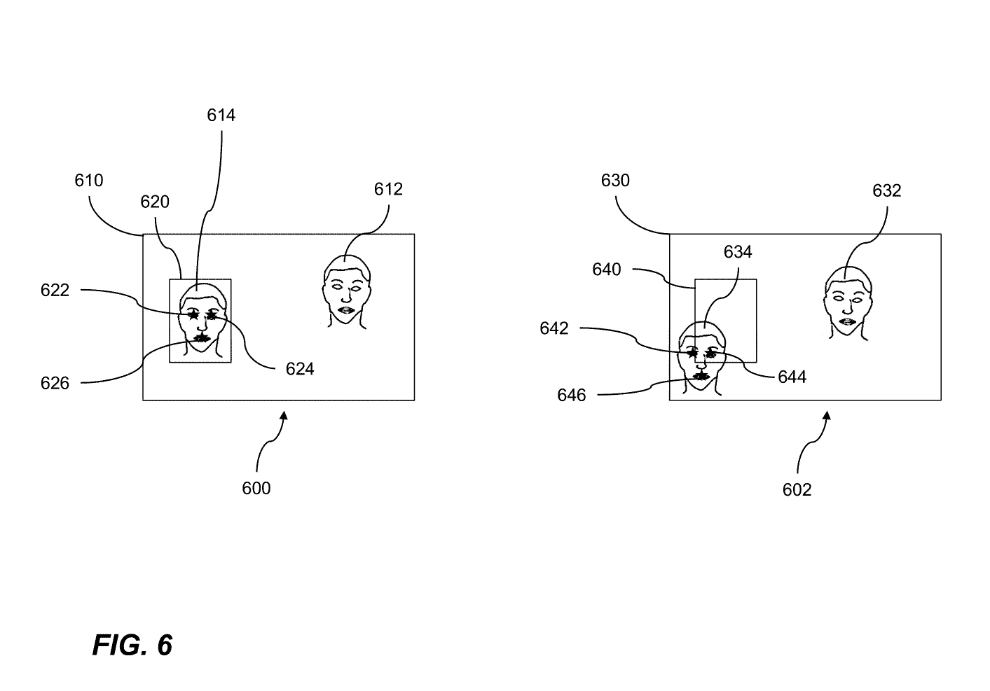

FIG. 6 illustrates feature extraction for multiple faces. The feature extraction for multiple faces can be performed for faces that can be detected in multiple images. The images can be analyzed for attendance query evaluation. A plurality of images can be received of an individual viewing an electronic display. A face can be identified in an image, based on the use of classifiers. The plurality of images can be evaluated to determine that the electronic display was attended by the individual. The feature extraction can be performed by analysis using one or more processors, using one or more video collection devices, and by using a server. The analysis device can be used to perform face detection for a second face, as well as for facial tracking of the first face. One or more videos can be captured, where the videos contain one or more faces. The video or videos that contain the one or more faces can be partitioned into a plurality of frames, and the frames can be analyzed for the detection of the one or more faces. The analysis of the one or more video frames can be based on one or more classifiers. A classifier can be an algorithm, heuristic, function, or piece of code that can be used to identify into which of a set of categories a new or particular observation, sample, datum, etc. should be placed. The decision to place an observation into a category can be based on training the algorithm or piece of code, by analyzing a known set of data, known as a training set. The training set can include data for which category memberships of the data can be known. The training set can be used as part of a supervised training technique. If a training set is not available, then a clustering technique can be used to group observations into categories. The latter approach, or unsupervised learning, can be based on a measure (i.e. distance) of one or more inherent similarities among the data that is being categorized. When the new observation is received, then the classifier can be used to categorize the new observation. Classifiers can be used for many analysis applications including analysis of one or more faces. The use of classifiers can be the basis of analyzing the one or more faces for gender, ethnicity, and age; for detection of one or more faces in one or more videos; for detection of facial features, for detection of facial landmarks, and so on. The observations can be analyzed based on one or more of a set of quantifiable properties. The properties can be described as features and explanatory variables and can include various data types that can include numerical (integer-valued, real-valued), ordinal, categorical, and so on. Some classifiers can be based on a comparison between an observation and prior observations, as well as based on functions such as a similarity function, a distance function, and so on.

Classification can be based on various types of algorithms, heuristics, codes, procedures, statistics, and so on. Many techniques exist for performing classification. This classification of one or more observations into one or more groups can be based on distributions of the data values, probabilities, and so on. Classifiers can be binary, multiclass, linear, and so on. Algorithms for classification can be implemented using a variety of techniques, including neural networks, kernel estimation, support vector machines, use of quadratic surfaces, and so on. Classification can be used in many application areas such as computer vision, speech and handwriting recognition, and so on. Classification can be used for biometric identification of one or more people in one or more frames of one or more videos.

Returning to FIG. 6, the detection of the first face, the second face, and multiple faces can include identifying facial landmarks, generating a bounding box, and prediction of a bounding box and landmarks for a next frame, where the next frame can be one of a plurality of frames of a video containing faces. A first video frame 600 includes a frame boundary 610, a first face 612, and a second face 614. The video frame 600 also includes a bounding box 620. Facial landmarks can be generated for the first face 612. Face detection can be performed to initialize a second set of locations for a second set of facial landmarks for a second face within the video. Facial landmarks in the video frame 600 can include the facial landmarks 622, 624, and 626. The facial landmarks can include corners of a mouth, corners of eyes, eyebrow corners, the tip of the nose, nostrils, chin, the tips of ears, and so on. The performing of face detection on the second face can include performing facial landmark detection with the first frame from the video for the second face, and can include estimating a second rough bounding box for the second face based on the facial landmark detection. The estimating of a second rough bounding box can include the bounding box 620. Bounding boxes can also be estimated for one or more other faces within the boundary 610. The bounding box can be refined, as can one or more facial landmarks. The refining of the second set of locations for the second set of facial landmarks can be based on localized information around the second set of facial landmarks. The bounding box 620 and the facial landmarks 622, 624, and 626 can be used to estimate future locations for the second set of locations for the second set of facial landmarks in a future video frame from the first video frame.

A second video frame 602 is also shown. The second video frame 602 includes a frame boundary 630, a first face 632, and a second face 634. The second video frame 602 also includes a bounding box 640 and the facial landmarks 642, 644, and 646. In other embodiments, multiple facial landmarks are generated and used for facial tracking of the two or more faces of a video frame, such as the shown second video frame 602. Facial points from the first face can be distinguished from other facial points. In embodiments, the other facial points include facial points of one or more other faces. The facial points can correspond to the facial points of the second face. The distinguishing of the facial points of the first face and the facial points of the second face can be used to distinguish between the first face and the second face, to track either or both of the first face and the second face, and so on. Other facial points can correspond to the second face. As mentioned above, multiple facial points can be determined within a frame. One or more of the other facial points that are determined can correspond to a third face. The location of the bounding box 640 can be estimated, where the estimating can be based on the location of the generated bounding box 620 shown in the first video frame 600. The three facial landmarks shown, facial landmarks 642, 644, and 646, might lie within the bounding box 640 or might not lie partially or completely within the bounding box 640. For instance, the second face 634 might have moved between the first video frame 600 and the second video frame 602. Based on the accuracy of the estimating of the bounding box 640, a new estimation can be determined for a third, future frame from the video, and so on. The evaluation can be performed, all or in part, on semiconductor based logic.

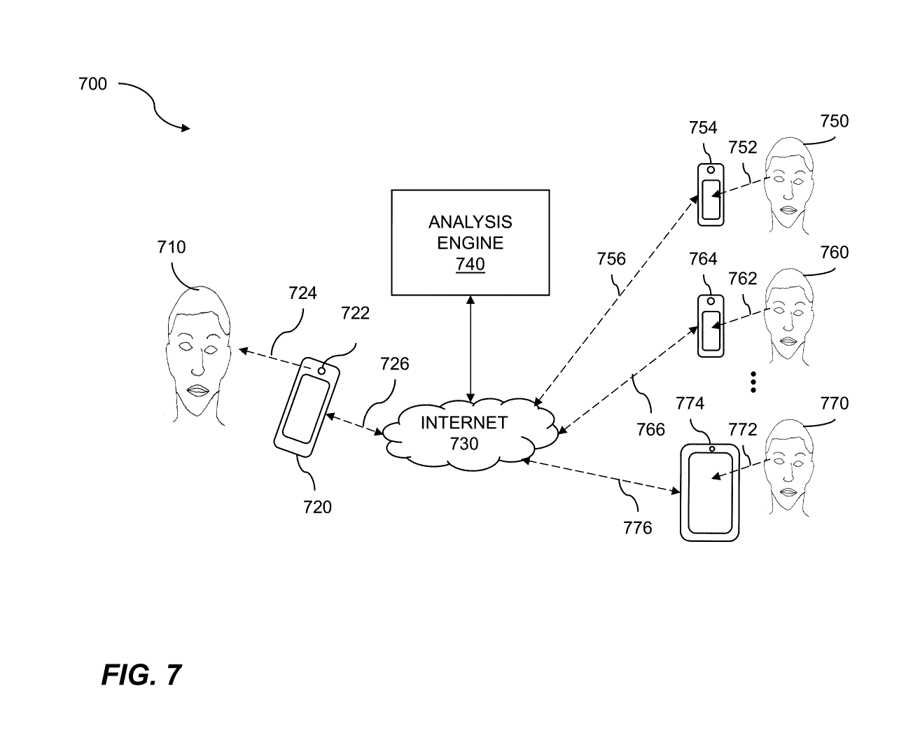

FIG. 7 shows live streaming of social video in light of viewership analysis. The live streaming of social video can be performed for data collected from evaluating images to determine that an electronic display is being attended. In embodiments, the evaluating the plurality of images includes scoring digital media content. The collected images can be analyzed for attendance query evaluation. A plurality of images of an individual viewing an electronic display can be received. A face can be identified in an image, based on the use of classifiers. The plurality of images can be evaluated to determine that the electronic display was attended by the individual. The streaming and analysis can be facilitated by a video capture device, a local server, a remote server, a semiconductor based logic, and so on. The streaming can be live streaming and can include mental state analysis, mental state event signature analysis, etc. Live streaming video is an example of one-to-many social media, where video can be sent over the Internet from one person to a plurality of people using a social media app and/or platform. Live streaming is one of numerous popular techniques used by people who want to disseminate ideas, send information, provide entertainment, share experiences, and so on. Some of the live streams can be scheduled, such as webcasts, online classes, sporting events, news, computer gaming, or video conferences, while others can be impromptu streams that are broadcasted as needed or when desirable. Examples of impromptu live stream videos can range from individuals simply wanting to share experiences with their social media followers, to live coverage of breaking news, emergencies, or natural disasters. The latter coverage is known as mobile journalism, or “mo jo”, and is becoming increasingly common. With this type of coverage, “reporters” can use networked, portable electronic devices to provide mobile journalism content to a plurality of social media followers. Such reporters can be quickly and inexpensively deployed as the need or desire arises.

Several live streaming social media apps and platforms can be used for transmitting video. One such video social media app is Meerkat™ that can link with a user's Twitter™ account. Meerkat™ enables a user to stream video using a handheld, networked electronic device coupled to video capabilities. Viewers of the live stream can comment on the stream using tweets that can be seen by and responded to by the broadcaster. Another popular app is Periscope™ that can transmit a live recording from one user to that user's Periscope™ account and other followers. The Periscope™ app can be executed on a mobile device. The user's Periscope™ followers can receive an alert whenever that user begins a video transmission. Another live-stream video platform is Twitch™ that can be used for video streaming of video gaming and broadcasts of various competitions and events.

The example 700 shows a user 710 broadcasting a video live-stream to one or more people as shown by the person 750, the person 760, and the person 770. A portable, network-enabled electronic device 720 can be coupled to a forward-facing camera 722. The portable electronic device 720 can be a smartphone, a PDA, a tablet, a laptop computer, and so on. The camera 722 coupled to the device 720 can have a line-of-sight view 724 to the user 710 and can capture video of the user 710. The captured video can be sent to an analysis or recommendation engine 740 using a network link 726 to the Internet 730. The network link can be a wireless link, a wired link, and so on. The recommendation engine 740 can recommend to the user 710 an app and/or platform that can be supported by the server and can be used to provide a video live stream to one or more followers of the user 710. In the example 700, the user 710 has three followers: the person 750, the person 760, and the person 770. Each follower has a line-of-sight view to a video screen on a portable, networked electronic device. In other embodiments, one or more followers follow the user 710 using any other networked electronic device, including a computer. In the example 700, the person 750 has a line-of-sight view 752 to the video screen of a device 754; the person 760 has a line-of-sight view 762 to the video screen of a device 764, and the person 770 has a line-of-sight view 772 to the video screen of a device 774. The portable electronic devices 754, 764, and 774 can each be a smartphone, a PDA, a tablet, and so on. Each portable device can receive the video stream being broadcasted by the user 710 through the Internet 730 using the app and/or platform that can be recommended by the recommendation engine 740. The device 754 can receive a video stream using the network link 756, the device 764 can receive a video stream using the network link 766, the device 774 can receive a video stream using the network link 776, and so on. The network link can be a wireless link, a wired link, a hybrid link, and so on. Depending on the app and/or platform that can be recommended by the recommendation engine 740, one or more followers, such as the followers 750, 760, 770, and so on, can reply to, comment on, and otherwise provide feedback to the user 710 using their devices 754, 764, and 774, respectively. In embodiments, an attendance query evaluation is performed on each follower (750, 760, and 770). An aggregate viewership score of the content generated by the user 710 can be calculated. The viewership score can be used to provide a ranking of the user 710 on a social media platform. In such an embodiment, users that provide more engaging and more frequently viewed content receive higher ratings.

The human face provides a powerful communications medium through its ability to exhibit a myriad of expressions that can be captured and analyzed for a variety of purposes. In some cases, media producers are acutely interested in evaluating the effectiveness of message delivery by video media. Such video media includes advertisements, political messages, educational materials, television programs, movies, government service announcements, etc. Automated facial analysis can be performed on one or more video frames containing a face in order to detect facial action. Based on the facial action detected, a variety of parameters can be determined, including affect valence, spontaneous reactions, facial action units, and so on. The parameters that are determined can be used to infer or predict emotional and mental states. For example, determined valence can be used to describe the emotional reaction of a viewer to a video media presentation or another type of presentation. Positive valence provides evidence that a viewer is experiencing a favorable emotional response to the video media presentation, while negative valence provides evidence that a viewer is experiencing an unfavorable emotional response to the video media presentation. Other facial data analysis can include the determination of discrete emotional states of the viewer or viewers.

Facial data can be collected from a plurality of people using any of a variety of cameras. A camera can include a webcam, a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. In some embodiments, the person is permitted to “opt-in” to the facial data collection. For example, the person can agree to the capture of facial data using a personal device such as a mobile device or another electronic device by selecting an opt-in choice. Opting-in can then turn on the person's webcam-enabled device and can begin the capture of the person's facial data via a video feed from the webcam or other camera. The video data that is collected can include one or more persons experiencing an event. The one or more persons can be sharing a personal electronic device or can each be using one or more devices for video capture. The videos that are collected can be collected using a web-based framework. The web-based framework can be used to display the video media presentation or event as well as to collect videos from multiple viewers who are online. That is, the collection of videos can be crowdsourced from those viewers who elected to opt-in to the video data collection.

The videos captured from the various viewers who chose to opt-in can be substantially different in terms of video quality, frame rate, etc. As a result, the facial video data can be scaled, rotated, and otherwise adjusted to improve consistency. Human factors further play into the capture of the facial video data. The facial data that is captured might or might not be relevant to the video media presentation being displayed. For example, the viewer might not be paying attention, might be fidgeting, might be distracted by an object or event near the viewer, or otherwise inattentive to the video media presentation. The behavior exhibited by the viewer can prove challenging to analyze due to viewer actions including eating, speaking to another person or persons, speaking on the phone, etc. The videos collected from the viewers might also include other artifacts that pose challenges during the analysis of the video data. The artifacts can include items such as eyeglasses (because of reflections), eye patches, jewelry, and clothing that occludes or obscures the viewer's face. Similarly, a viewer's hair or hair covering can present artifacts by obscuring the viewer's eyes and/or face.

The captured facial data can be analyzed using the facial action coding system (FACS). The FACS seeks to define groups or taxonomies of facial movements of the human face. The FACS encodes movements of individual muscles of the face, where the muscle movements often include slight, instantaneous changes in facial appearance. The FACS encoding is commonly performed by trained observers but can also be performed on automated, computer-based systems. Analysis of the FACS encoding can be used to determine emotions of the persons whose facial data is captured in the videos. The FACS is used to encode a wide range of facial expressions that are anatomically possible for the human face. The FACS encodings include action units (AUs) and related temporal segments that are based on the captured facial expression. The AUs are open to higher order interpretation and decision-making. These AUs can be used to recognize emotions experienced by the observed person. Emotion-related facial actions can be identified using the emotional facial action coding system (EMFACS) and the facial action coding system affect interpretation dictionary (FACSAID). For a given emotion, specific action units can be related to the emotion. For example, the emotion of anger can be related to AUs 4, 5, 7, and 23, while happiness can be related to AUs 6 and 12. Other mappings of emotions to AUs have also been previously associated. The coding of the AUs can include an intensity scoring that ranges from A (trace) to E (maximum). The AUs can be used for analyzing images to identify patterns indicative of a particular mental and/or emotional state. The AUs range in number from 0 (neutral face) to 98 (fast up-down look). The AUs include so-called main codes (inner brow raiser, lid tightener, etc.), head movement codes (head turn left, head up, etc.), eye movement codes (eyes turned left, eyes up, etc.), visibility codes (eyes not visible, entire face not visible, etc.), and gross behavior codes (sniff, swallow, etc.). Emotion scoring can be included where intensity is evaluated, as well as specific emotions, moods, or mental states.

The coding of faces identified in videos captured of people observing an event can be automated. The automated systems can detect facial AUs or discrete emotional states. The emotional states can include amusement, fear, anger, disgust, surprise, and sadness. The automated systems can be based on a probability estimate from one or more classifiers, where the probabilities can correlate with an intensity of an AU or an expression. The classifiers can be used to identify into which of a set of categories a given observation can be placed. In some cases, the classifiers can be used to determine a probability that a given AU or expression is present in a given frame of a video. The classifiers can be used as part of a supervised machine learning technique, where the machine learning technique can be trained using “known good” data. Once trained, the machine learning technique can proceed to classify new data that is captured.

The supervised machine learning models can be based on support vector machines (SVMs). An SVM can have an associated learning model that is used for data analysis and pattern analysis. For example, an SVM can be used to classify data that can be obtained from collected videos of people experiencing a media presentation. An SVM can be trained using “known good” data that is labeled as belonging to one of two categories (e.g. smile and no-smile). The SVM can build a model that assigns new data into one of the two categories. The SVM can construct one or more hyperplanes that can be used for classification. The hyperplane that has the largest distance from the nearest training point can be determined to have the best separation. The largest separation can improve the classification technique by increasing the probability that a given data point can be properly classified.

In another example, a histogram of oriented gradients (HoG) can be computed. The HoG can include feature descriptors and can be computed for one or more facial regions of interest. The regions of interest of the face can be located using facial landmark points, where the facial landmark points can include outer edges of nostrils, outer edges of the mouth, outer edges of eyes, etc. A HoG for a given region of interest can count occurrences of gradient orientation within a given section of a frame from a video, for example. The gradients can be intensity gradients and can be used to describe an appearance and a shape of a local object. The HoG descriptors can be determined by dividing an image into small, connected regions, also called cells. A histogram of gradient directions or edge orientations can be computed for pixels in the cell. Histograms can be contrast-normalized based on intensity across a portion of the image or the entire image, thus reducing any influence from illumination or shadowing changes between and among video frames. The HoG can be computed on the image or on an adjusted version of the image, where the adjustment of the image can include scaling, rotation, etc. The image can be adjusted by flipping the image around a vertical line through the middle of a face in the image. The symmetry plane of the image can be determined from the tracker points and landmarks of the image.

In embodiments, an automated facial analysis system identifies five facial actions or action combinations in order to detect spontaneous facial expressions for media research purposes. Based on the facial expressions that are detected, a determination can be made with regard to the effectiveness of a given video media presentation, for example. The system can detect the presence of the AUs or the combination of AUs in videos collected from a plurality of people. The facial analysis technique can be trained using a web-based framework to crowdsource videos of people as they watch online video content. The video can be streamed at a fixed frame rate to a server. Human labelers can code for the presence or absence of facial actions including a symmetric smile, unilateral smile, asymmetric smile, and so on. The trained system can then be used to automatically code the facial data collected from a plurality of viewers experiencing video presentations (e.g. television programs).

Spontaneous asymmetric smiles can be detected in order to understand viewer experiences. Related literature indicates that as many asymmetric smiles occur on the right hemi face as do on the left hemi face, for spontaneous expressions. Detection can be treated as a binary classification problem, where images that contain a right asymmetric expression are used as positive (target class) samples and all other images as negative (non-target class) samples. Classifiers perform the classification, including classifiers such as support vector machines (SVM) and random forests. Random forests can include ensemble-learning methods that use multiple learning algorithms to obtain better predictive performance. Frame-by-frame detection can be performed to recognize the presence of an asymmetric expression in each frame of a video. Facial points can be detected, including the top of the mouth and the two outer eye corners. The face can be extracted, cropped and warped into a pixel image of specific dimension (e.g. 96×96 pixels). In embodiments, the inter-ocular distance and vertical scale in the pixel image are fixed. Feature extraction can be performed using computer vision software such as OpenCV™. Feature extraction can be based on the use of HoGs. HoGs can include feature descriptors and can be used to count occurrences of gradient orientation in localized portions or regions of the image. Other techniques can be used for counting occurrences of gradient orientation, including edge orientation histograms, scale-invariant feature transformation descriptors, etc. The AU recognition tasks can also be performed using Local Binary Patterns (LBP) and Local Gabor Binary Patterns (LGBP). The HoG descriptor represents the face as a distribution of intensity gradients and edge directions, and is robust in its ability to translate and scale. Differing patterns, including groupings of cells of various sizes and arranged in variously sized cell blocks, can be used. For example, 4×4 cell blocks of 8×8 pixel cells with an overlap of half of the block can be used. Histograms of channels can be used, including nine channels or bins evenly spread over 0-180 degrees. In this example, the HoG descriptor on a 96×96 image is 25 blocks×16 cells×9 bins=3600, the latter quantity representing the dimension. AU occurrences can be rendered. The videos can be grouped into demographic datasets based on nationality and/or other demographic parameters for further detailed analysis. This grouping and other analyses can be facilitated via semiconductor based logic.

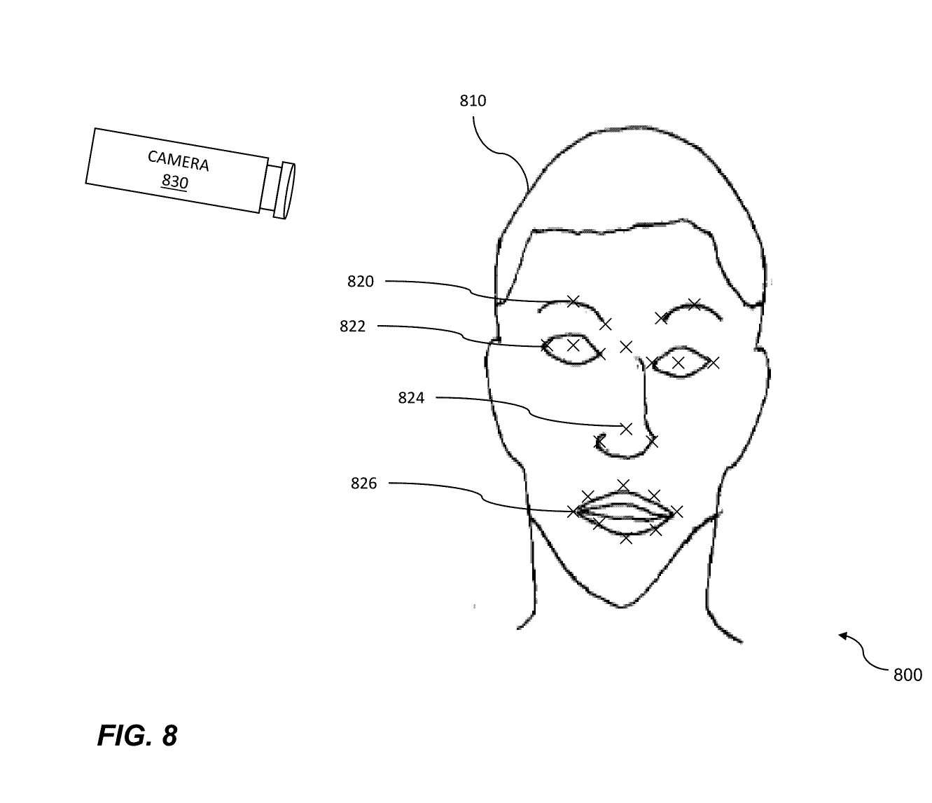

FIG. 8 shows example facial data collection including landmarks. The collecting of facial data including landmarks can be performed for images that have been collected of an individual. The collected images can be analyzed for attendance query evaluation. A plurality of images of an individual viewing an electronic display can be received. A face can be identified in an image, based on the use of classifiers. The plurality of images can be evaluated to determine that the electronic display was attended by the individual. In the example 800, facial data including facial landmarks can be collected using a variety of electronic hardware and software techniques. The collecting of facial data including landmarks can be based on sub-sectional components of a population. The sub-sectional components can be used with performing the evaluation of content of the face, identifying facial landmarks, etc. The sub-sectional components can be used to provide a context. A face 810 can be observed using a camera 830 in order to collect facial data that includes facial landmarks. The facial data can be collected from a plurality of people using one or more of a variety of cameras. As previously discussed, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The quality and usefulness of the facial data that is captured can depend on the position of the camera 830 relative to the face 810, the number of cameras used, the illumination of the face, etc. In some cases, if the face 810 is poorly lit or over-exposed (e.g. in an area of bright light), the processing of the facial data to identify facial landmarks might be rendered more difficult. In another example, the camera 830 being positioned to the side of the person might prevent capture of the full face. Artifacts can degrade the capture of facial data. For example, the person's hair, prosthetic devices (e.g. glasses, an eye patch, and eye coverings), jewelry, and clothing can partially or completely occlude or obscure the person's face. Data relating to various facial landmarks can include a variety of facial features. The facial features can comprise an eyebrow 820, an outer eye edge 822, a nose 824, a corner of a mouth 826, and so on. Multiple facial landmarks can be identified from the facial data that is captured. The facial landmarks that are identified can be analyzed to identify facial action units. The action units that can be identified can include AUO2 outer brow raiser, AU14 dimpler, AU17 chin raiser, and so on. Multiple action units can be identified. The action units can be used alone and/or in combination to infer one or more mental states and emotions. A similar process can be applied to gesture analysis (e.g. hand gestures) with all of the analysis being accomplished or augmented by a mobile device, a server, semiconductor-based logic, and so on.

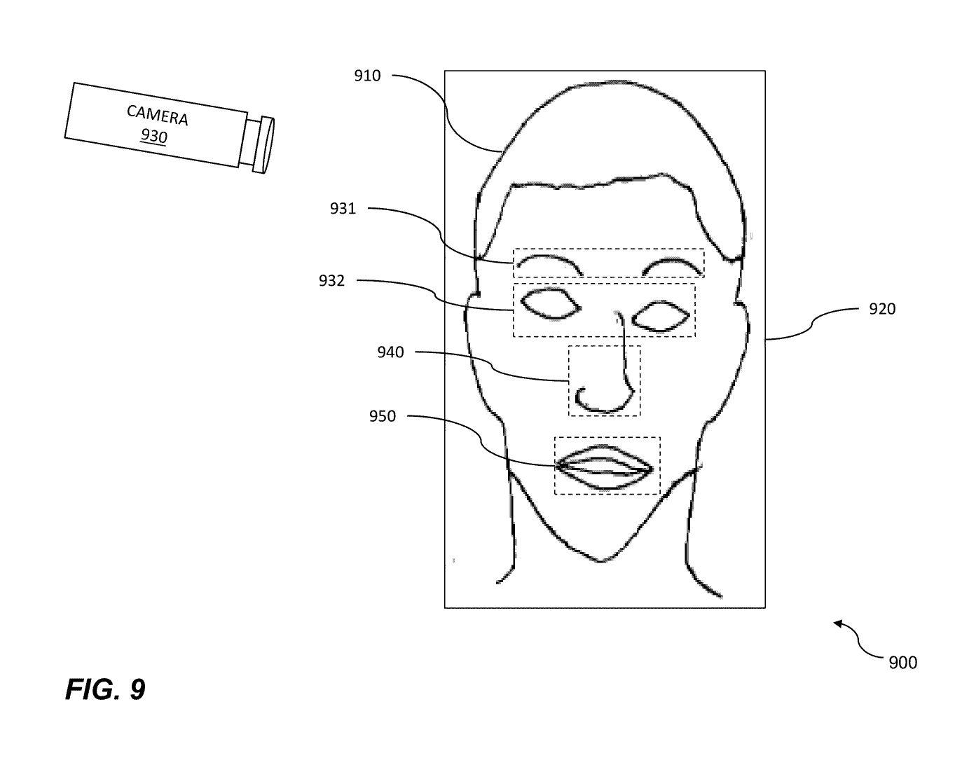

FIG. 9 shows example facial data collection including regions. The collecting of facial data including regions can be performed for images collected of an individual. The collected images can be analyzed for attendance query evaluation. A plurality of images of an individual viewing an electronic display can be received. A face can be identified in an image, based on the use of classifiers. The plurality of images can be evaluated to determine that the electronic display was attended by the individual. Various regions of a face can be identified and used for a variety of purposes including facial recognition, facial analysis, and so on. The collecting of facial data including regions can be based on sub-sectional components of a population. The sub-sectional components can be used with performing the evaluation of content of the face, identifying facial regions, etc. The sub-sectional components can be used to provide a context. Facial analysis can be used to determine, predict, estimate, etc. mental states, emotions, and so on of a person from whom facial data can be collected. In embodiments, the one or more emotions that can be determined by the analysis can be represented by an image, a figure, an icon, etc. The representative icon can include an emoji. One or more emoji can be used to represent a mental state, a mood, etc. of an individual; to represent food, a geographic location, weather, and so on. The emoji can include a static image. The static image can be a predefined size such as a certain number of pixels. The emoji can include an animated image. The emoji can be based on a GIF or another animation standard. The emoji can include a cartoon representation. The cartoon representation can be any cartoon type, format, etc. that can be appropriate to representing an emoji. In the example 900, facial data can be collected, where the facial data can include regions of a face. The facial data that is collected can be based on sub-sectional components of a population. When more than one face can be detected in an image, facial data can be collected for one face, some faces, all faces, and so on. The facial data which can include facial regions can be collected using any of a variety of electronic hardware and software techniques. The facial data can be collected using sensors including motion sensors, infrared sensors, physiological sensors, imaging sensors, and so on. A face 910 can be observed using a camera 930, a sensor, a combination of cameras and/or sensors, and so on. The camera 930 can be used to collect facial data that can be used to determine that a face is present in an image. When a face is present in an image, a bounding box 920 can be placed around the face. Placement of the bounding box around the face can be based on detection of facial landmarks. The camera 930 can be used to collect facial data from the bounding box 920, where the facial data can include facial regions. The facial data can be collected from a plurality of people using any of a variety of cameras. As discussed previously, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. As discussed previously, the quality and usefulness of the facial data that is captured can depend on, among other examples, the position of the camera 930 relative to the face 910, the number of cameras and/or sensors used, the illumination of the face, any obstructions to viewing the face, and so on.

The facial regions that can be collected by the camera 930, a sensor, or a combination of cameras and/or sensors can include any of a variety of facial features. Embodiments include determining regions within the face of the individual and evaluating the regions for emotional content. The facial features that can be included in the facial regions that are collected can include eyebrows 931, eyes 932, a nose 940, a mouth 950, ears, hair, texture, tone, and so on. Multiple facial features can be included in one or more facial regions. The number of facial features that can be included in the facial regions can depend on the desired amount of data to be captured, whether a face is in profile, whether the face is partially occluded or obstructed, etc. The facial regions that can include one or more facial features can be analyzed to determine facial expressions. The analysis of the facial regions can also include determining probabilities of occurrence of one or more facial expressions. The facial features that can be analyzed can also include textures, gradients, colors, shapes, etc. The facial features can be used to determine demographic data, where the demographic data can include age, ethnicity, culture, gender, etc. Multiple textures, gradients, colors, shapes, and so on, can be detected by the camera 930, a sensor, or a combination of cameras and sensors. Texture, brightness, and color, for example, can be used to detect boundaries in an image for detection of a face, facial features, facial landmarks, and so on.

A texture in a facial region can include facial characteristics, skin types, and so on. In some instances, a texture in a facial region can include smile lines, crow's feet, wrinkles, and so on. Another texture that can be used to evaluate a facial region can include a smooth potion of skin such as a smooth portion of a check. A gradient in a facial region can include values assigned to local skin texture, shading, etc. A gradient can be used to encode a texture by computing magnitudes in a local neighborhood or portion of an image. The computed values can be compared to discrimination levels, threshold values, and so on. The gradient can be used to determine gender, facial expression, etc. A color in a facial region can include eye color, skin color, hair color, and so on. A color can be used to determine demographic data, where the demographic data can include ethnicity, culture, age, gender, etc. A shape in a facial region can include the shape of a face, eyes, nose, mouth, ears, and so on. As with color in a facial region, shape in a facial region can be used to determine demographic data including ethnicity, culture, age, gender, and so on.

The facial regions can be detected based on detection of edges, boundaries, and so on, of features that can be included in an image. The detection can be based on various types of analysis of the image. The features that can be included in the image can include one or more faces. A boundary can refer to a contour in an image plane, where the contour can represent ownership of a particular picture element (pixel) from one object, feature, etc. in the image, to another object, feature, and so on, in the image. An edge can be a distinct, low-level change of one or more features in an image. That is, an edge can be detected based on a change, including an abrupt change such as in color, brightness, etc. within an image. In embodiments, image classifiers are used for the analysis. The image classifiers can include algorithms, heuristics, and so on, and can be implemented using functions, classes, subroutines, code segments, etc. The classifiers can be used to detect facial regions, facial features, and so on. As discussed above, the classifiers can be used to detect textures, gradients, color, shapes, edges, etc. Any classifier can be used for the analysis, including, but not limited to, density estimation, support vector machines (SVM), logistic regression, classification trees, and so on. By way of example, consider facial features that can include the eyebrows 931. One or more classifiers can be used to analyze the facial regions that can include the eyebrows to determine a probability for either a presence or an absence of an eyebrow furrow. The probability can include a posterior probability, a conditional probability, and so on. The probabilities can be based on Bayesian Statistics or other statistical analysis technique. The presence of an eyebrow furrow can indicate the person from whom the facial data was collected is annoyed, confused, unhappy, and so on. In another example, consider facial features that can include a mouth 950. One or more classifiers can be used to analyze the facial region that can include the mouth to determine a probability for either a presence or an absence of mouth edges turned up to form a smile. Multiple classifiers can be used to determine one or more facial expressions.

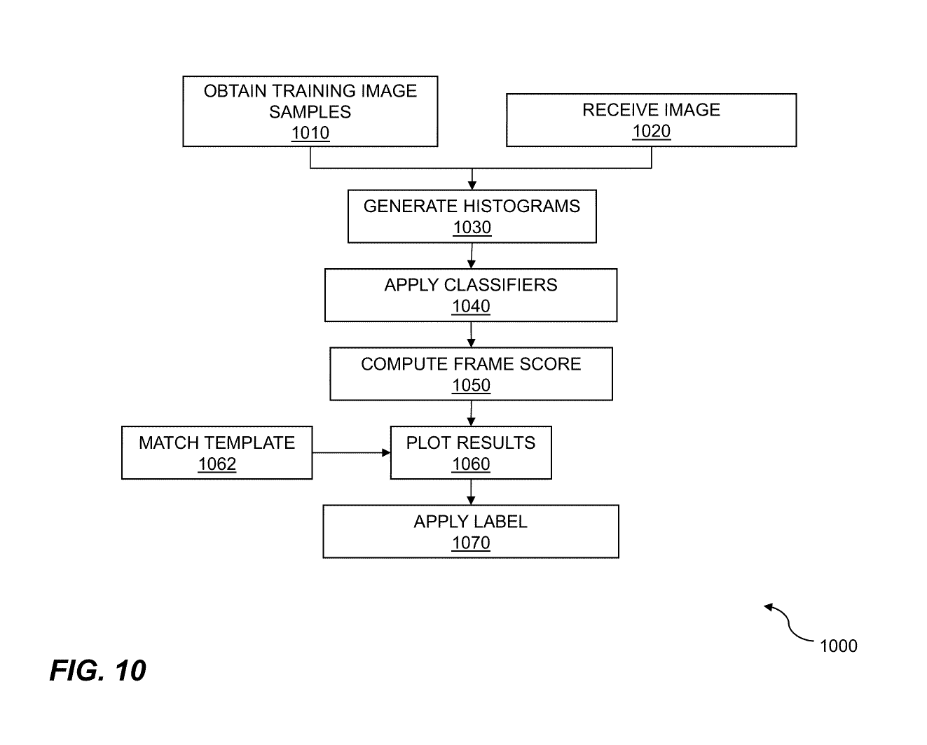

FIG. 10 is a flow diagram for detecting facial expressions. The detection of facial expressions can be performed for data collected from images of an individual. The collected images can be analyzed for attendance query evaluation. A plurality of images can be received of an individual viewing an electronic display. A face can be identified in an image, based on the use of classifiers. The plurality of images can be evaluated to determine that the electronic display was attended by the individual. The flow 1000, or portions thereof, can be implemented in semiconductor logic, can be accomplished using a mobile device, can be accomplished using a server device, and so on. The flow 1000 can be used to automatically detect a wide range of facial expressions. A facial expression can produce strong emotional signals that can indicate valence and discrete emotional states. The discrete emotional states can include contempt, doubt, defiance, happiness, fear, anxiety, and so on. The detection of facial expressions can be based on the location of facial landmarks. The detection of facial expressions can be based on determination of action units (AU), where the action units are determined using FACS coding. The AUs can be used singly or in combination to identify facial expressions. Based on the facial landmarks, one or more AUs can be identified by number and intensity. For example, AU12 can be used to code a lip corner puller and can be used to infer a smirk.

The flow 1000 begins by obtaining training image samples 1010. The image samples can include a plurality of images of one or more people. Human coders who are trained to correctly identify AU codes based on the FACS can code the images. The training or “known good” images can be used as a basis for training a machine learning technique. Once trained, the machine learning technique can be used to identify AUs in other images that can be collected using a camera, a sensor, and so on. The flow 1000 continues with receiving an image 1020. The image 1020 can be received from a camera, a sensor, and so on. As previously discussed, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The image that is received can be manipulated in order to improve the processing of the image. For example, the image can be cropped, scaled, stretched, rotated, flipped, etc. in order to obtain a resulting image that can be analyzed more efficiently. Multiple versions of the same image can be analyzed. In some cases, the manipulated image and a flipped or mirrored version of the manipulated image can be analyzed alone and/or in combination to improve analysis. The flow 1000 continues with generating histograms 1030 for the training images and the one or more versions of the received image. The histograms can be based on a HoG or another histogram. As described in previous paragraphs, the HoG can include feature descriptors and can be computed for one or more regions of interest in the training images and the one or more received images. The regions of interest in the images can be located using facial landmark points, where the facial landmark points can include outer edges of nostrils, outer edges of the mouth, outer edges of eyes, etc. A HoG for a given region of interest can count occurrences of gradient orientation within a given section of a frame from a video.

The flow 1000 continues with applying classifiers 1040 to the histograms. The classifiers can be used to estimate probabilities, where the probabilities can correlate with an intensity of an AU or an expression. In some embodiments, the choice of classifiers used is based on the training of a supervised learning technique to identify facial expressions. The classifiers can be used to identify into which of a set of categories a given observation can be placed. The classifiers can be used to determine a probability that a given AU or expression is present in a given image or frame of a video. In various embodiments, the one or more AUs that are present include AU01 inner brow raiser, AU12 lip corner puller, AU38 nostril dilator, and so on. In practice, the presence or absence of multiple AUs can be determined. The flow 1000 continues with computing a frame score 1050. The score computed for an image, where the image can be a frame from a video, can be used to determine the presence of a facial expression in the image or video frame. The score can be based on one or more versions of the image 1020 or a manipulated image. The score can be based on a comparison of the manipulated image to a flipped or mirrored version of the manipulated image. The score can be used to predict a likelihood that one or more facial expressions are present in the image. The likelihood can be based on computing a difference between the outputs of a classifier used on the manipulated image and on the flipped or mirrored image, for example. The classifier that is used can be used to identify symmetrical facial expressions (e.g. smile), asymmetrical facial expressions (e.g. outer brow raiser), and so on.

The flow 1000 continues with plotting results 1060. The results that are plotted can include one or more scores for one or more frames computed over a given time t. For example, the plotted results can include classifier probability results from analysis of HoGs for a sequence of images and video frames. The plotted results can be matched with a template 1062. The template can be temporal and can be represented by a centered box function or another function. A best fit with one or more templates can be found by computing a minimum error. Other best-fit techniques can include polynomial curve fitting, geometric curve fitting, and so on. The flow 1000 continues with applying a label 1070. The label can be used to indicate that a particular facial expression has been detected in the one or more images or video frames which constitute the image 1020 that was received. The label can be used to indicate that any of a range of facial expressions has been detected, including a smile, an asymmetric smile, a frown, and so on. Various steps in the flow 1000 may be changed in order, repeated, omitted, or the like without departing from the disclosed concepts. Various embodiments of the flow 1000 can be included in a computer program product embodied in a non-transitory computer readable medium that includes code executable by one or more processors. Various embodiments of the flow 1000, or portions thereof, can be included on a semiconductor chip and implemented in special purpose logic, programmable logic, and so on.

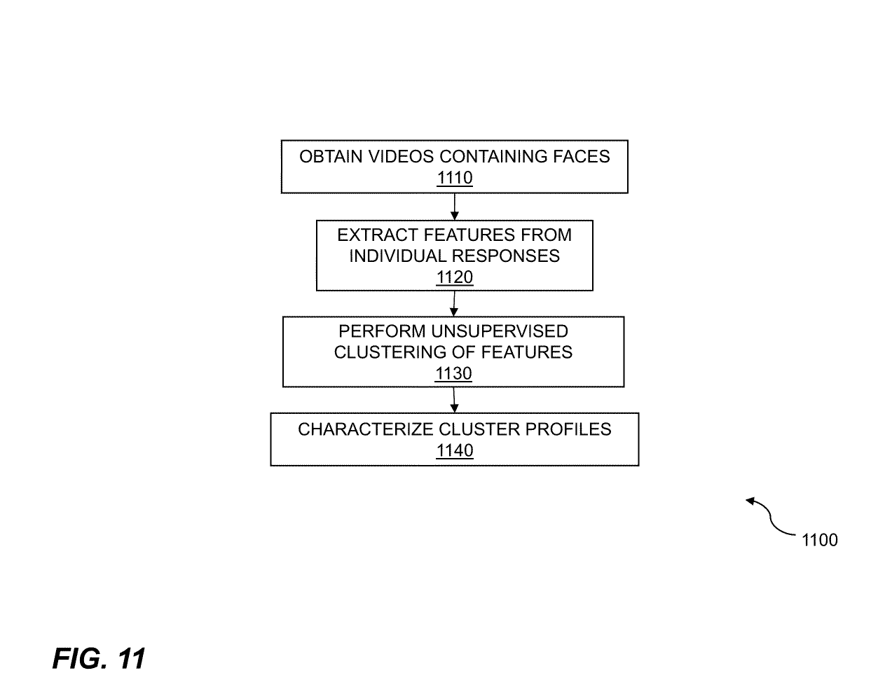

FIG. 11 is a flow diagram for the large-scale clustering of facial events. The large-scale clustering of facial events can be performed for data collected from images of an individual. The collected images can be analyzed for attendance query evaluation. A plurality of images can be received of an individual viewing an electronic display. A face can be identified in an image, based on the use of classifiers. The plurality of images can be evaluated to determine that the electronic display was attended by the individual. The clustering and evaluation of facial events can be augmented using a mobile device, a server, semiconductor based logic, and so on. As discussed above, collection of facial video data from one or more people can include a web-based framework. The web-based framework can be used to collect facial video data from large numbers of people located over a wide geographic area. The web-based framework can include an opt-in feature that allows people to agree to facial data collection. The web-based framework can be used to render and display data to one or more people and can collect data from the one or more people. For example, the facial data collection can be based on showing one or more viewers a video media presentation through a website. The web-based framework can be used to display the video media presentation or event and to collect videos from multiple viewers who are online. That is, the collection of videos can be crowdsourced from those viewers who elected to opt-in to the video data collection. The video event can be a commercial, a political ad, an educational segment, and so on.

The flow 1100 begins with obtaining videos containing faces 1110. The videos can be obtained using one or more cameras, where the cameras can include a webcam coupled to one or more devices employed by the one or more people using the web-based framework. The flow 1100 continues with extracting features from the individual responses 1120. The individual responses can include videos containing faces observed by the one or more webcams. The features that are extracted can include facial features such as an eyebrow, a nostril, an eye edge, a mouth edge, and so on. The feature extraction can be based on facial coding classifiers, where the facial coding classifiers output a probability that a specified facial action has been detected in a given video frame. The flow 1100 continues with performing unsupervised clustering of features 1130. The unsupervised clustering can be based on an event. The unsupervised clustering can be based on a K-Means, where the K of the K-Means can be computed using a Bayesian Information Criterion (BICk), for example, to determine the smallest value of K that meets system requirements. Any other criterion for K can be used. The K-Means clustering technique can be used to group one or more events into various respective categories.

The flow 1100 continues with characterizing cluster profiles 1140. The profiles can include a variety of facial expressions such as smiles, asymmetric smiles, eyebrow raisers, eyebrow lowerers, etc. The profiles can be related to a given event. For example, a humorous video can be displayed in the web-based framework and the video data of people who have opted-in can be collected. The characterization of the collected and analyzed video can depend in part on the number of smiles that occurred at various points throughout the humorous video. The number of smiles resulting from people viewing a humorous video can be compared to various demographic groups, where the groups can be formed based on geographic location, age, ethnicity, gender, and so on. Similarly, the characterization can be performed on collected and analyzed videos of people viewing a news presentation. The characterized cluster profiles can be further analyzed based on demographic data. Various steps in the flow 1100 may be changed in order, repeated, omitted, or the like without departing from the disclosed concepts. Various embodiments of the flow 1100 can be included in a computer program product embodied in a non-transitory computer readable medium that includes code executable by one or more processors. Various embodiments of the flow 1100, or portions thereof, can be included on a semiconductor chip and implemented in special purpose logic, programmable logic, and so on.

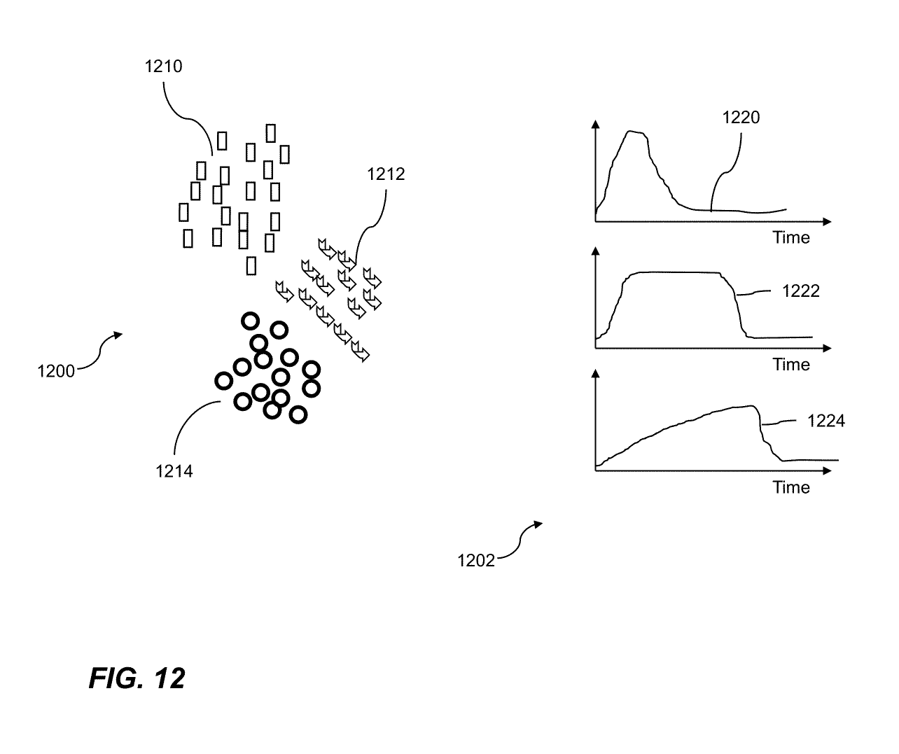

FIG. 12 shows unsupervised clustering of features and characterizations of cluster profiles. The clustering of features and characterizations of cluster profiles can be performed for images collected of an individual. The collected images can be analyzed for attendance query evaluation. A plurality of images can be received of an individual viewing an electronic display. A face can be identified in an image, based on the use of classifiers. The plurality of images can be evaluated to determine that the electronic display was attended by the individual. Features including samples of facial data can be clustered using unsupervised clustering. Various clusters can be formed which include similar groupings of facial data observations. The example 1200 shows three clusters, clusters 1210, 1212, and 1214. The clusters can be based on video collected from people who have opted-in to video collection. When the data collected is captured using a web-based framework, the data collection can be performed on a grand scale, including hundreds, thousands, or even more participants who can be located locally and/or across a wide geographic area. Unsupervised clustering is a technique that can be used to process the large amounts of captured facial data and to identify groupings of similar observations. The unsupervised clustering can also be used to characterize the groups of similar observations. The characterizations can include identifying behaviors of the participants. The characterizations can be based on identifying facial expressions and facial action units of the participants. Some behaviors and facial expressions can include faster or slower onsets, faster or slower offsets, longer or shorter durations, etc. The onsets, offsets, and durations can all correlate to time. The data clustering that results from the unsupervised clustering can support data labeling. The labeling can include FACS coding. The clusters can be partially or totally based on a facial expression resulting from participants viewing a video presentation, where the video presentation can be an advertisement, a political message, educational material, a public service announcement, and so on. The clusters can be correlated with demographic information, where the demographic information can include educational level, geographic location, age, gender, income level, and so on.

The cluster profiles 1202 can be generated based on the clusters that can be formed from unsupervised clustering, with time shown on the x-axis and intensity or frequency shown on the y-axis. The cluster profiles can be based on captured facial data including facial expressions. The cluster profile 1220 can be based on the cluster 1210, the cluster profile 1222 can be based on the cluster 1212, and the cluster profile 1224 can be based on the cluster 1214. The cluster profiles 1220, 1222, and 1224 can be based on smiles, smirks, frowns, or any other facial expression. The emotional states of the people who have opted-in to video collection can be inferred by analyzing the clustered facial expression data. The cluster profiles can be plotted with respect to time and can show a rate of onset, a duration, and an offset (rate of decay). Other time-related factors can be included in the cluster profiles. The cluster profiles can be correlated with demographic information, as described above.

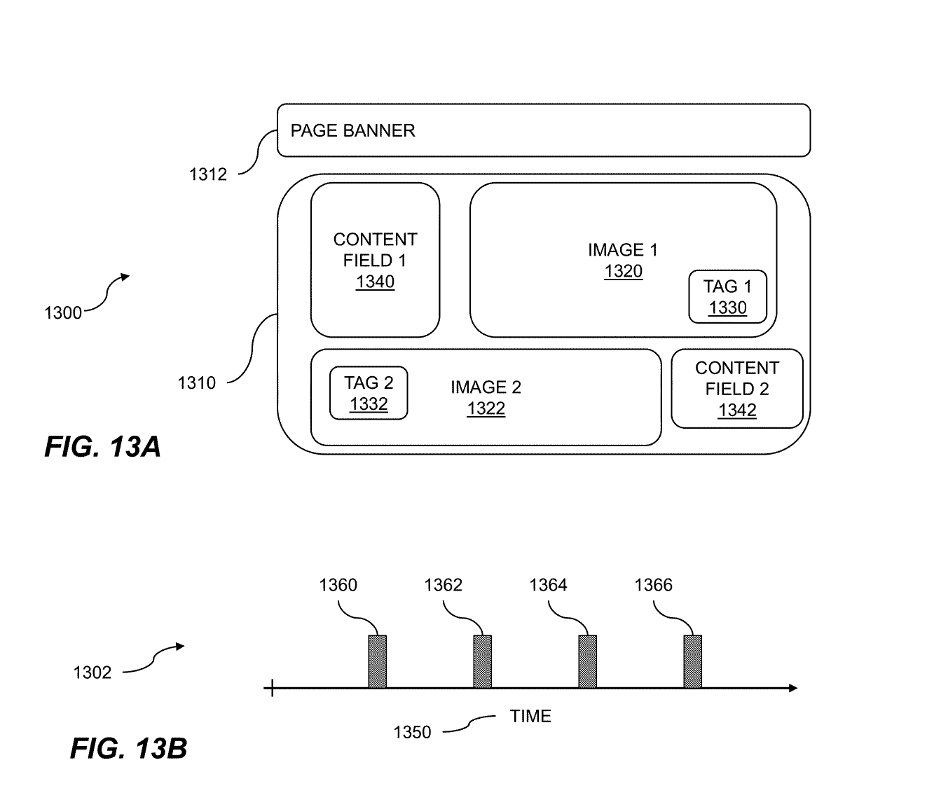

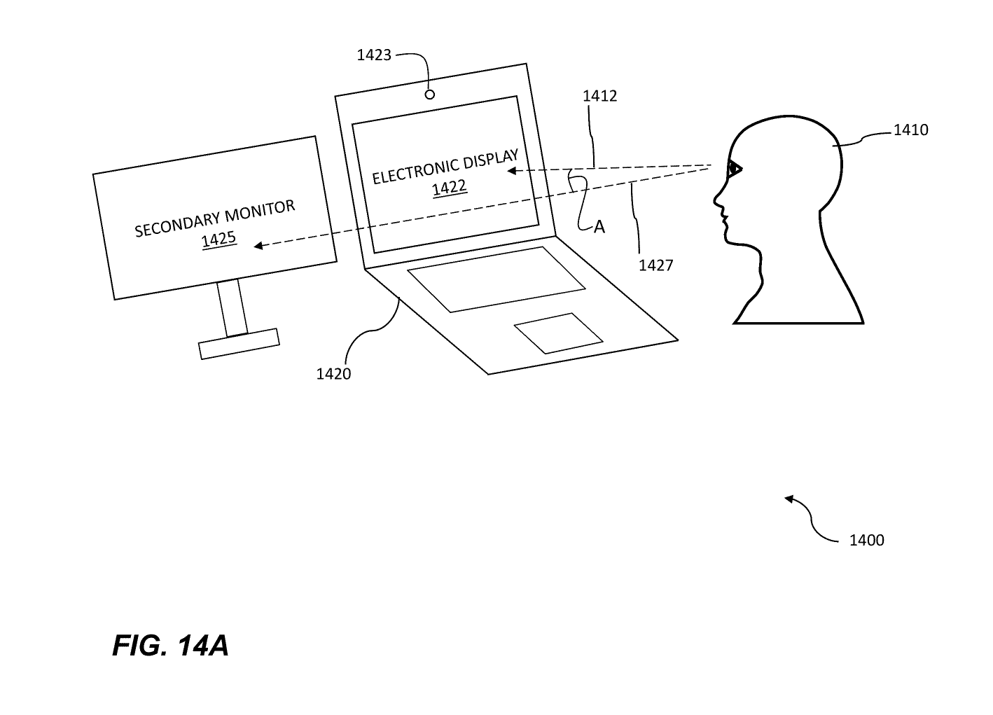

FIG. 13A shows example tags embedded in a webpage. The tags embedded in the webpage can be used for image analysis for images collected of an individual. The collected images can be analyzed for attendance query evaluation. A plurality of images can be received of an individual viewing an electronic display. A face can be identified in an image, based on the use of classifiers. The plurality of images can be evaluated to determine that the electronic display was attended by the individual. Once a tag is detected, a mobile device, a server, semiconductor based logic, etc. can be used to evaluate associated facial expressions. A webpage 1300 can include a page body 1310, a page banner 1312, and so on. The page body can include one or more objects, where the objects can include text, images, videos, audio, and so on. The example page body 1310 shown includes a first image, image 1 1320; a second image, image 2 1322; a first content field, content field 1 1340; and a second content field, content field 2 1342. In practice, the page body 1310 can contain multiple images and content fields, and can include one or more videos, one or more audio presentations, and so on. The page body can include embedded tags, such as tag 1 1330 and tag 2 1332. In the example shown, tag 1 1330 is embedded in image 1 1320, and tag 2 1332 is embedded in image 2 1322. In embodiments, multiple tags are imbedded. Tags can also be imbedded in content fields, in videos, in audio presentations, etc. When a user mouses over a tag or clicks on an object associated with a tag, the tag can be invoked. For example, when the user mouses over tag 1 1330, tag 1 1330 can then be invoked. Invoking tag 1 1330 can include enabling a camera coupled to a user's device and capturing one or more images of the user as the user views a media presentation (or digital experience). In a similar manner, when the user mouses over tag 2 1332, tag 2 1332 can be invoked. Invoking tag 2 1332 can also include enabling the camera and capturing images of the user. In other embodiments, other actions are taken based on invocation of the one or more tags. Invoking an embedded tag can initiate an analysis technique, post to social media, award the user a coupon or another prize, initiate mental state analysis, perform emotion analysis, and so on.

FIG. 13B shows invoking tags to collect images. The invoking tags to collect images can be used for image analysis for images collected of an individual. The collected images can be analyzed for attendance query evaluation. A plurality of images can be received of an individual viewing an electronic display. A face can be identified in an image, based on the use of classifiers. The plurality of images can be evaluated to determine that the electronic display was attended by the individual. As previously stated, a media presentation can be a video, a webpage, and so on. A video 1302 can include one or more embedded tags, such as a tag 1360, another tag 1362, a third tag 1364, a fourth tag 1366, and so on. In practice, multiple tags can be included in the media presentation. The one or more tags can be invoked during the media presentation. The collection of the invoked tags can occur over time, as represented by a timeline 1350. When a tag is encountered in the media presentation, the tag can be invoked. When the tag 1360 is encountered, invoking the tag can enable a camera coupled to a user device and can capture one or more images of the user viewing the media presentation. Invoking a tag can depend on opt-in by the user. For example, if a user has agreed to participate in a study by indicating an opt-in, then the camera coupled to the user's device can be enabled and one or more images of the user can be captured. If the user has not agreed to participate in the study and has not indicated an opt-in, then invoking the tag 1360 does not enable the camera nor capture images of the user during the media presentation. The user can indicate an opt-in for certain types of participation, where opting-in can be dependent on specific content in the media presentation. The user could opt-in to participation in a study of political campaign messages and not opt-in for a particular advertisement study. In this case, tags that are related to political campaign messages, advertising messages, social media sharing, etc. and that enable the camera and image capture when invoked would be embedded in the media presentation social media sharing, and so on. However, tags imbedded in the media presentation that are related to advertisements would not enable the camera when invoked. Various other situations of tag invocation are possible.

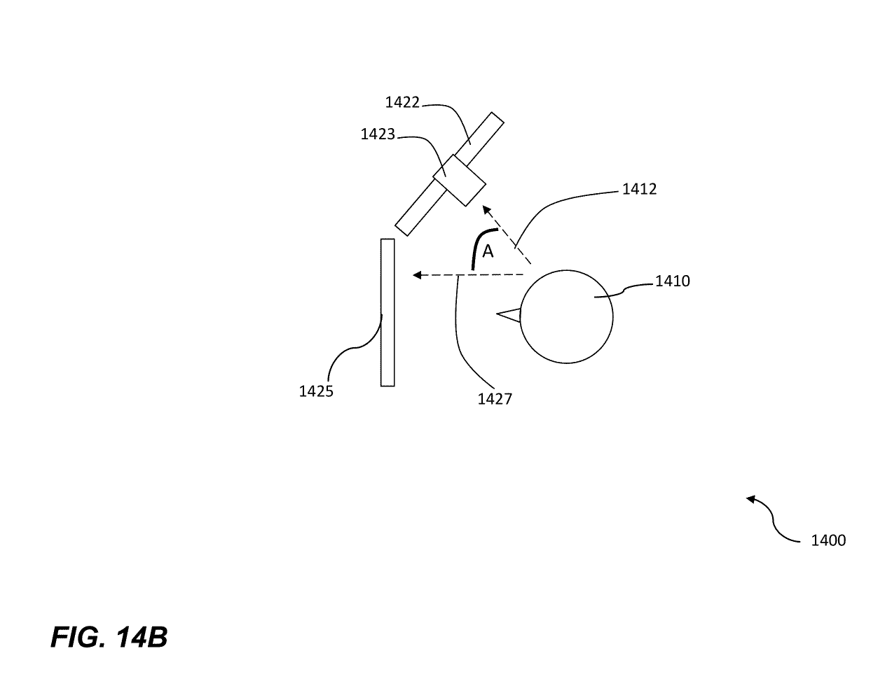

FIG. 14A shows a perspective view of an embodiment utilizing multiple screens. FIG. 14B shows a top-down view of a similar setup. The example 1400 shows a person 1410 facing, and viewing an event on, a secondary monitor 1425. An event can be a media presentation, where the media presentation can be viewed on an electronic display. The media presentation can be an advertisement, a political campaign announcement, a TV show, a movie, a video clip, or any other type of media presentation. In the example 1400, the person 1410 has a line of sight 1412 to a computer 1420 that includes an electronic display 1422 and an integrated webcam 1423. The secondary monitor 1425 can be connected to the computer and serve to mirror the electronic display 1422 of the computer 1420. In other embodiments, the secondary monitor 1425 extends the desktop of the computer 1420. In yet other embodiments, the secondary monitor 1425 is independent of the computer 1420. For example, the secondary monitor 1425 can be connected to a cable television feed, while the laptop is placed off to the side of the user. In embodiments, the secondary monitor 1425 is much larger than the electronic display 1422 of the computer 1420, and hence, it is much easier for a user to watch content on the monitor 1425 than the display 1422. In such a configuration, the camera 1423 is at an angle A to the line of sight 1427 of the secondary monitor 1425. Thus, the camera 1423 can capture a head pose that is off-center with respect to the camera, and the system can identify the off-center head pose as directed towards the secondary monitor. In order to more accurately perform the attendance query evaluation, embodiments allow a user to perform a calibration. The calibration allows the system to record an off-center head pose and associate it with viewing of a secondary monitor.

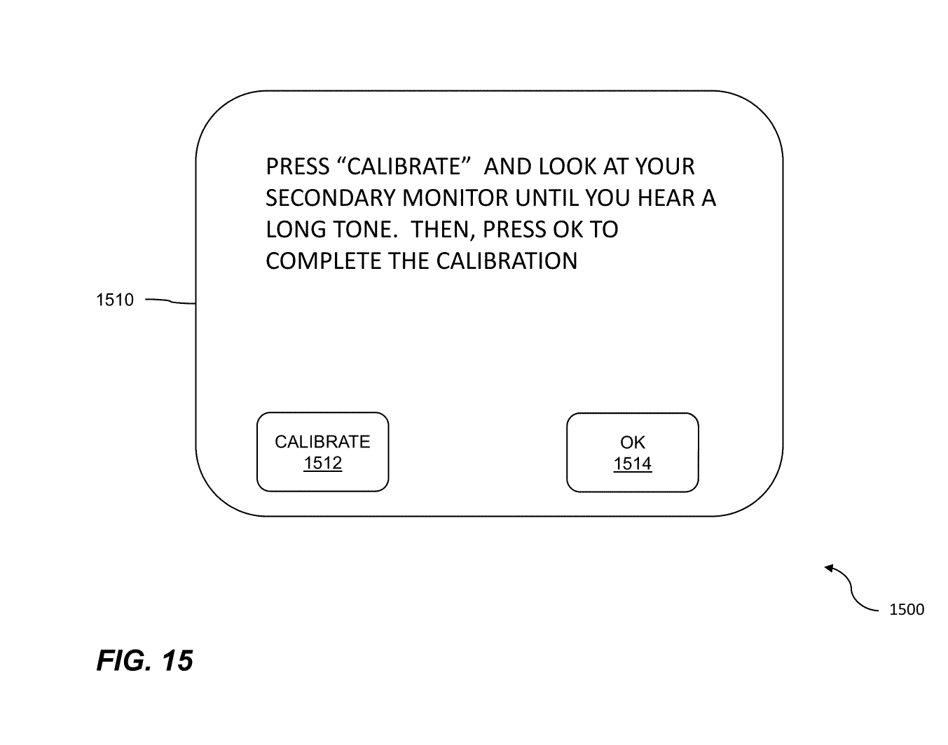

FIG. 15 shows an exemplary calibration user interface 1500 for a multiple screen embodiment. The calibration can include presenting a user interface screen 1510 on the electronic display 1422 of the computer 1420 (shown in FIG. 14A and FIG. 14B). The user is instructed to press (or click on) the calibrate button 1512. Once they press the calibrate button, they look at the secondary monitor for a time period, while the computer 1420 issues short beeping sounds. During the calibration process, the webcam 1423 acquires images indicative of a user facing the secondary monitor 1425 (shown in FIG. 14A and FIG. 14B). When a sufficient number of images are acquired, the computer 1420 issues a long beeping sound to indicate that the calibration is complete. In embodiments, the short beeping sounds each range from 200 milliseconds to 500 milliseconds in duration, and the long beeping sound ranges from about 3 seconds to about 5 seconds. Once the calibration process is complete, the user presses the OK button 1514 to perform any additional saving of calibration data and exit the user interface screen 1510. In this way, embodiments are utilized on displays that do not have an integrated camera facing the viewer.

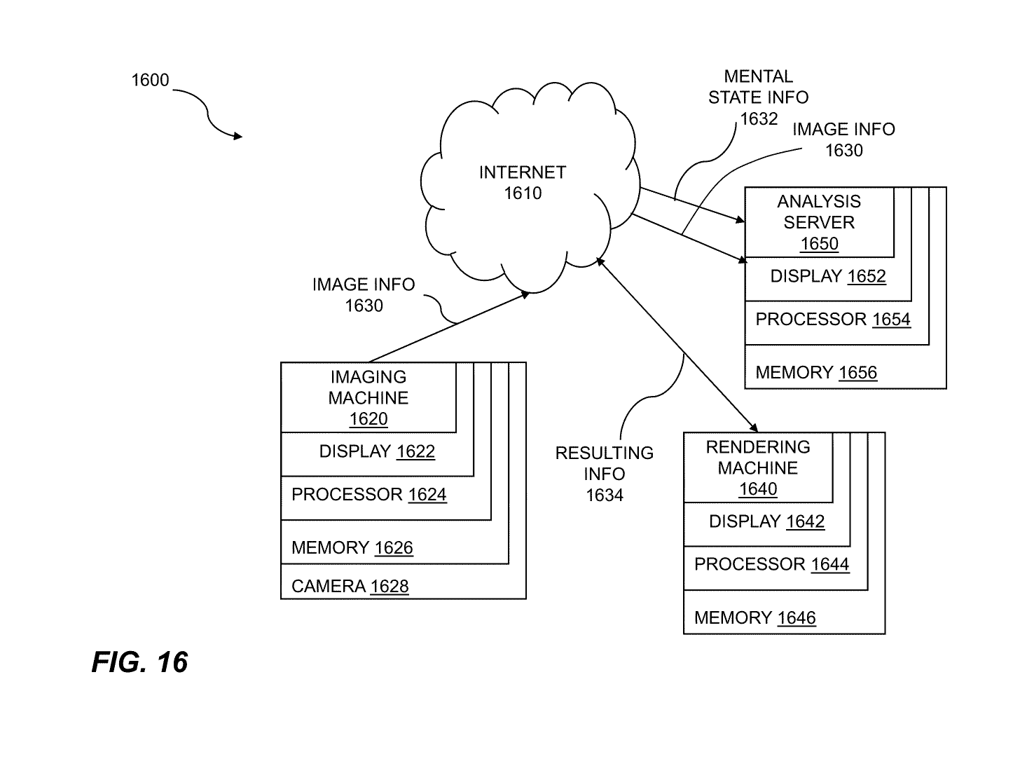

FIG. 16 is a diagram of a system for analyzing images for attendance query evaluation. The system 1600 can include one or more imaging machines 1620 linked to an analysis server 1650 and a rendering machine 1640 via the Internet 1610 or another computer network. The network can be wired or wireless, a combination of wired and wireless networks, and so on. Image information 1630 can be transferred to the analysis server 1650 through the Internet 1610, for example. The example imaging machine 1620 shown comprises one or more processors 1624 coupled to a memory 1626 which can store and retrieve instructions, a display 1622, and a camera 1628. The camera 1628 can include a webcam, a video camera, a still camera, a thermal imager, a CCD device, a phone camera, a three-dimensional camera, a depth camera, a light field camera, multiple webcams used to show different views of a person, or any other type of image capture technique that can allow captured data to be used in an electronic system. The memory 1626 can be used for storing instructions, image data on a plurality of people, one or more classifiers, one or more action units, and so on. The display 1622 can be any electronic display, including but not limited to, a computer display, a laptop screen, a net-book screen, a tablet computer screen, a smartphone display, a mobile device display, a remote with a display, a television, a projector, or the like. Mental state information 1632 can be transferred via the Internet 1610 for a variety of purposes including analysis, rendering, storage, cloud storage, sharing, social sharing, and so on.

The analysis server 1650 can include one or more processors 1654 coupled to a memory 1656 which can store and retrieve instructions, and can also include a display 1652. The analysis server 1650 can receive mental state information 1632 and image information 1630 and analyze the information using classifiers, action units, and so on. The classifiers and action units can be stored in the analysis server, loaded into the analysis server, provided by a user of the analysis server, and so on. The analysis server 1650 can use image data received from the imaging machine 1620 to produce resulting information 1634. The resulting information can include viewership, viewability, attendance query evaluations, emotion, mood, mental state, etc., and can be based on the image information 1630. In some embodiments, the analysis server 1650 receives image data from a plurality of imaging machines, aggregates the image data, processes the image data or the aggregated image data, and so on.

The rendering machine 1640 can include one or more processors 1644 coupled to a memory 1646 which can store and retrieve instructions and data, and can also include a display 1642. The rendering of the resulting information 1634 can occur on the rendering machine 1640 or on a different platform from the rendering machine 1640. In embodiments, the rendering of the resulting information rendering data occurs on the imaging machine 1620 or on the analysis server 1650. As shown in the system 1600, the rendering machine 1640 can receive resulting information 1634 via the Internet 1610 or another network from the imaging machine 1620, from the analysis server 1650, or from both. The rendering can include a visual display or any other appropriate display format.

The system 1600 can include a computer program product embodied in a non-transitory computer readable medium for analysis, the computer program product comprising: code for receiving a plurality of images of an individual viewing an electronic display; code for identifying a face of the individual wherein the identifying is based on a plurality of image classifiers and wherein the identifying occurs for at least one of the plurality of images; and code for evaluating the plurality of images to determine that the electronic display was attended by the individual.

The system 1600 can include a computer system for analysis comprising: a memory which stores instructions; one or more processors attached to the memory wherein the one or more processors, when executing the instructions which are stored, are configured to: receive a plurality of images of an individual viewing an electronic display; identify a face of the individual wherein the identifying is based on a plurality of image classifiers and wherein the identifying occurs for at least one of the plurality of images; and evaluate the plurality of images to determine that the electronic display was attended by the individual.

In embodiments, a validation study can be performed to demonstrate an accuracy of a viewership metric. The validation study can be laboratory based and can include any number of samples. The lab study can simulate the types of distractions consumers can be expected to experience. Distractions can include phones ringing, text messages arriving, another person in the room, etc. Participants can be asked to watch content. At set time periods, various distracting events can take place. The experimental results can be used to build a taxonomy and examples that describe viewership behaviors. The accuracy of the viewership metric can be demonstrated based on a ground-truth dataset.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Prolog, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for analysis comprising:
receiving a plurality of images of an individual viewing an electronic display;
identifying a face of the individual wherein:
the identifying is based on a plurality of image classifiers;
the identifying occurs for at least one of the plurality of images; and
the plurality of image classifiers are used to perform head pose estimation; and
evaluating the plurality of images to determine that the electronic display was attended by the individual with the face.

2. The method of claim 1 wherein the receiving is in response to tagging of media rendered on the electronic display.

3. The method of claim 1 wherein being attended by the individual includes viewing of the electronic display.

4. The method of claim 3 wherein determination that the electronic display was attended is used in determining viewership.

5. The method of claim 3 wherein the electronic display renders an object and the viewing includes viewing the object.

6. The method of claim 1 wherein being attended by the individual includes determining viewability of digital media content from the electronic display.

7. The method of claim 6 wherein viewability includes evaluation of presence of digital media content and whether the digital media content is viewable by the individual.

8. The method of claim 7 wherein the evaluating the plurality of images includes scoring the digital media content.

9. The method of claim 8 wherein the scoring includes scoring for emotional reaction by the individual.

10. The method of claim 9 wherein the emotional reaction includes engagement.

11. The method of claim 8 wherein the digital media content includes an advertisement.

12. The method of claim 7 further comprising modifying the digital media content based on the viewability.

13. The method of claim 6 further comprising modifying the digital media content based on viewership.

14. The method of claim 1 further comprising performing eye gaze detection using the plurality of image classifiers.

15. The method of claim 1 wherein the evaluating the plurality of images is accomplished without eye tracking.

16. The method of claim 1 wherein the electronic display renders an advertisement and the advertisement has tagging incorporated.

17. The method of claim 16 further comprising invoking the evaluating based on the tagging that was incorporated.

18-19. (canceled)

20. The method of claim 1 further comprising determining an engagement score for the individual.

21. (canceled)

22. The method of claim 1 wherein an image classifier from the plurality of image classifiers is used to evaluate head pose for the individual.

23. The method of claim 1 wherein the evaluating is used as part of a viewership determination across a plurality of people.

24. The method of claim 1 further comprising evaluating emotional responses by the individual.

25. The method of claim 1 further comprising opting in by the individual for collection of the plurality of images.

26. The method of claim 25 wherein the opting in is persistent and was accomplished before an advertisement is rendered on the electronic display.

27-28. (canceled)

29. The method of claim 1 further comprising receiving a second plurality of images of a second individual viewing a second electronic display; identifying a second face of the second individual wherein the identifying the second face is based on the plurality of image classifiers and wherein the identifying the second face occurs for at least one of the second plurality of images; evaluating the second plurality of images to determine that the second electronic display was attended by the second individual; and determining a viewership score based on the evaluating the plurality of images and the evaluating the second plurality of images.

30. The method of claim 1 wherein the evaluating comprises: determining regions within the face of the individual and evaluating the regions for emotional content.

31. A computer program product embodied in a non-transitory computer readable medium for analysis, the computer program product comprising:
code for receiving a plurality of images of an individual viewing an electronic display;
code for identifying a face of the individual wherein:
the identifying is based on a plurality of image classifiers;
the identifying occurs for at least one of the plurality of images; and
the plurality of image classifiers are used to perform head pose estimation; and
code for evaluating the plurality of images to determine that the electronic display was attended by the individual.

32. A computer system for analysis comprising:
a memory which stores instructions;
one or more processors attached to the memory wherein the one or more processors, when executing the instructions which are stored, are configured to:
receive a plurality of images of an individual viewing an electronic display;
identify a face of the individual wherein:
identification is based on a plurality of image classifiers;
identification occurs for at least one of the plurality of images; and
the plurality of image classifiers are used to perform head pose estimation; and
evaluate the plurality of images to determine that the electronic display was attended by the individual with the face.
